(19) United States
(12) Patent Application Publication
(10) Pub. No.: US 2010/0201531 A1
(43) Pub. Date: Aug. 12, 2010

(54) CARBON MONOXIDE DETECTOR

(75) Inventors: Alireza Pakravan, Centennial, CO (US); Daniel Duchesne, Parker, CO (US)

Correspondence Address: Berenbaum Weinshienk PC, 370 Seventeenth Street, Republic Plaza, Suite 4800, Denver, CO, 80202, US

(73) Assignee: NEW WORLD PRODUCTS, LLC, Centennial, CO (US)

(21) Appl. No.: 12/703,087

(22) Filed: Feb. 9, 2010

Related U.S. Application Data
(60) Provisional application No. 61/151,062, filed on Feb. 9, 2009.
(60) Provisional application No. 61/252,595, filed on Oct. 16, 2009.

(51) Int. Cl. G08B 17/10; G01N 19/10

(52) U.S. Cl. 340/632; 73/29.02

(57) ABSTRACT

A carbon monoxide detection apparatus having one or more carbon monoxide sensors operatively connected to an appliance. The one or more carbon monoxide sensors can detect a threshold level of carbon monoxide and cause the detection apparatus to activate the appliance cutoff switch. Alternatively, the connection to the appliance may be for the measurement of carbon monoxide in a substantially continuously flowing airstream; and/or for measuring in two air locations, one an airstream and the other ambient. An audible alarm may be included for sounding an audible alarm. A separate device may be included which may be activated or deactivated.

This application claims the benefit of priority under 35 U.S.C. §119(e) from U.S. Provisional Patent Application No. 61/151,062, entitled “CARBON MONOXIDE DETECTOR,” filed Feb. 9, 2009, which is incorporated herein in its entirety by this reference, and the benefit of priority under 35 U.S.C. §119(e) from U.S. Provisional Patent Application No. 61/252,595, entitled “CARBON MONOXIDE DETECTOR,” filed Oct. 16, 2009, which is incorporated herein in its entirety by this reference.

### BACKGROUND

The present developments are directed generally to carbon monoxide detection, but more particularly to a carbon monoxide detector that can be adapted to improve detection, as for example in being calibrated for humidity and/or for connection to an appliance, such as a gas appliance, the detector optionally also being adapted to sense carbon monoxide substantially continuously in an airstream, sense carbon monoxide in dual locations as in an airstream and in ambient air, and/or shut off the appliance if the carbon monoxide detector reads a particular carbon monoxide quantity.

Carbon monoxide is an invisible, odorless, tasteless gas that arises from the incomplete combustion of some fossil fuels. In a residential situation, carbon monoxide can be formed, for example, by furnaces, water heaters, space heaters, ranges, ovens, ranges, fireplaces, grills, other sources of open flames, blocked chimneys or by running a car inside a garage.

Generally, carbon monoxide is present in low levels in ambient air. However, when it is present in high levels, or in lower levels over a period of time, it can be harmful. Carbon monoxide detectors detect the accumulation of carbon monoxide generally in an enclosed space such as a house or apartment, and trigger an alarm if the carbon monoxide level exceeds a predetermined amount. Most existing carbon monoxide detectors sound an alarm if the carbon monoxide reaches a certain threshold. At present, typical carbon monoxide detectors on the market sound an audible alarm when they sense approximately 70 parts per million (ppm) of carbon monoxide after 60 to 240 minutes.

### SUMMARY

In some implementations, a carbon monoxide detector or system hereof may be adapted or disposed to one or more of sense carbon monoxide substantially continuously in or from a flowing airstream, sense carbon monoxide in dual locations as in an airstream and in ambient air, and/or shut off an appliance if the carbon monoxide detector reads a particular carbon monoxide quantity. The appliance to be shut off may be a gas appliance such as a forced air gas furnace, boiler, powered water heater, or any gas powered appliance if the appliance emits carbon monoxide. The carbon monoxide detector may include operation by triggering a switch, e.g., by opening a normally closed or closing a normally open switch that will stop the appliance from running once it reads a threshold such as 50 ppm or more of carbon monoxide, depending upon the setting, and providing for the switch to remain inactivating the appliance until it is reset. A detection unit or system hereof may also sound an audible alarm. It may further be connected to a second hardwired or wireless extra alarm for more warning coverage. The carbon monoxide device or system may also be connected to a separate device, for example, a garage door, enabling the garage door to be operated or opened automatically upon attainment of a particular threshold level of carbon monoxide. It may also be connected to one or more gas cutoff valves, or to a further external device such as a fan or motor. Generally speaking, any building or household device which may have its power circuit completed by opening a normally closed or closing a normally open switch or relay on or in the detector device or system, thus completing the power supply circuit to the building or household device, may be integrated with a carbon monoxide detector device or system hereof and made operational, or deactivated, upon attainment and sensing of a certain threshold of carbon monoxide.

### BRIEF DESCRIPTION OF THE DRAWINGS

In the drawings:

FIG. 1 is a flow chart of a carbon monoxide detection device or system hereof.

FIG. 2, which includes sub-part FIGS. 2A and 2B, provides a system and flow chart of the operation of a device or system according hereto.

FIG. 3 provides an exploded isometric view of a device and/or system hereof.

FIG. 4 shows a plan view of a device hereof.

FIG. 5 provides a schematic diagram of some circuitry hereof.

FIG. 6, which includes sub-part FIGS. 6A and 6B, shows exemplar schematic state diagrams.

FIG. 7 shows a portion of a circuit diagram of a present development as set forth herein.

FIG. 8 shows another portion of a circuit diagram of a present development as set forth herein.

FIG. 9 shows another portion of a circuit diagram of a present development as set forth herein.

FIG. 10 shows another portion of a circuit diagram of a present development as set forth herein.

FIG. 11 shows another portion of a circuit diagram of a present development as set forth herein.

FIG. 12 shows another portion of a circuit diagram of a present development as set forth herein.

FIG. 13 shows another portion of a circuit diagram of a present development as set forth herein.

FIG. 14 shows another portion of a circuit diagram of a present development as set forth herein.

FIG. 15 shows another portion of a circuit diagram of a present development as set forth herein.

FIG. 16 shows another portion of a circuit diagram of a present development as set forth herein.

FIG. 17 shows another portion of a circuit diagram of a present development as set forth herein.

FIG. 18 shows another portion of a circuit diagram of a present development as set forth herein.

FIG. 19 shows another portion of a circuit diagram of a present development as set forth herein.

FIG. 20 shows another portion of a circuit diagram of a present development as set forth herein.

FIG. 21 shows another portion of a circuit diagram of a present development as set forth herein.

FIG. 22 shows another portion of a circuit diagram of a present development as set forth herein.

FIG. 23 shows another portion of a circuit diagram of a present development as set forth herein.

FIG. 24 shows another portion of a circuit diagram of a present development as set forth herein.

FIG. 25 shows another portion of a circuit diagram of a present development as set forth herein.

FIG. 26 shows another portion of a circuit diagram of a present development as set forth herein.

FIG. 27 shows another portion of a circuit diagram of a present development as set forth herein.

FIG. 28 shows another portion of a circuit diagram of a present development as set forth herein.

FIG. 29 shows another portion of a circuit diagram of a present development as set forth herein.

FIG. 30 shows a diagram of some dip switch settings for SW3.

FIG. 31 shows a diagram of some dip switch settings for SW3 for a vacation mode setting.

FIG. 32 shows a diagram of a dip switch sensor grouping and dip switch settings for SW4.

### DETAILED DESCRIPTION

A carbon monoxide detector device and/or system of the present developments may have or include one or in many instances at least two carbon monoxide sensors disposed therein. One such sensor may be disposed to sense carbon monoxide, also referred to as CO herein, in a particular gas stream, such as a stream of exhaust air, or in a forced air stream or cold air return duct of a forced air gas furnace. Alternatively, or additionally, a sensor may be disposed to sense CO in ambient air.

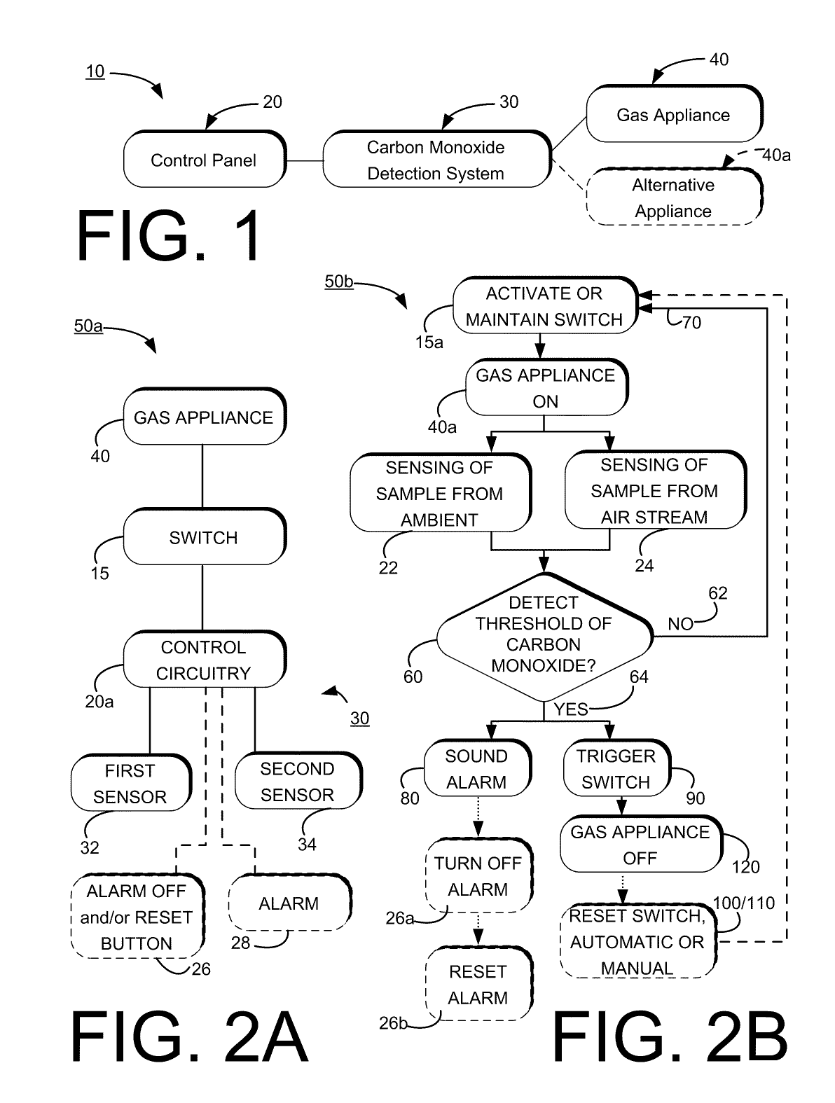

In the attached figures, more detailed examples are set forth. In FIG. 1, for example, the chart 10 illustrates the very high level of connectivity of a control panel 20, a carbon monoxide detection system 30, and an appliance 40. The control panel 20 is connected to the carbon monoxide detection system 30, which in turn is connected to the appliance 40 which may be a gas powered appliance, for example. The connection of the detection system or device to the appliance may be for detecting carbon monoxide including one or both of sensing carbon monoxide in a substantially continuous stream or sensing carbon monoxide in a substantially continuous stream by a first sensor, and sensing a discrete carbon monoxide quantity in ambient air by a second sensor. Also, either additionally or alternatively, the connection may be for the shutting down of the appliance upon detection of a threshold level of CO. In an alternative or as an additional connection, the appliance 40 may represent a separate discrete device, or an additional alternative connected device 40a may be included such as a garage door or an external fan, that could be integrated with the carbon monoxide detection system for activation or deactivation.

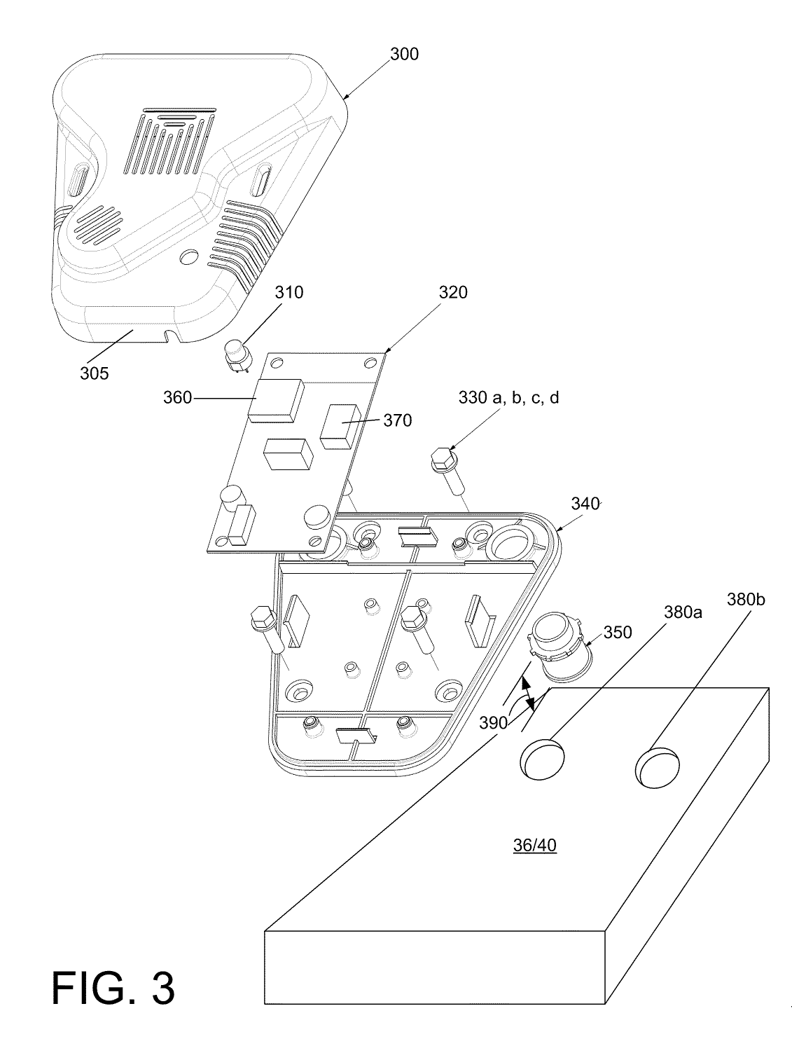

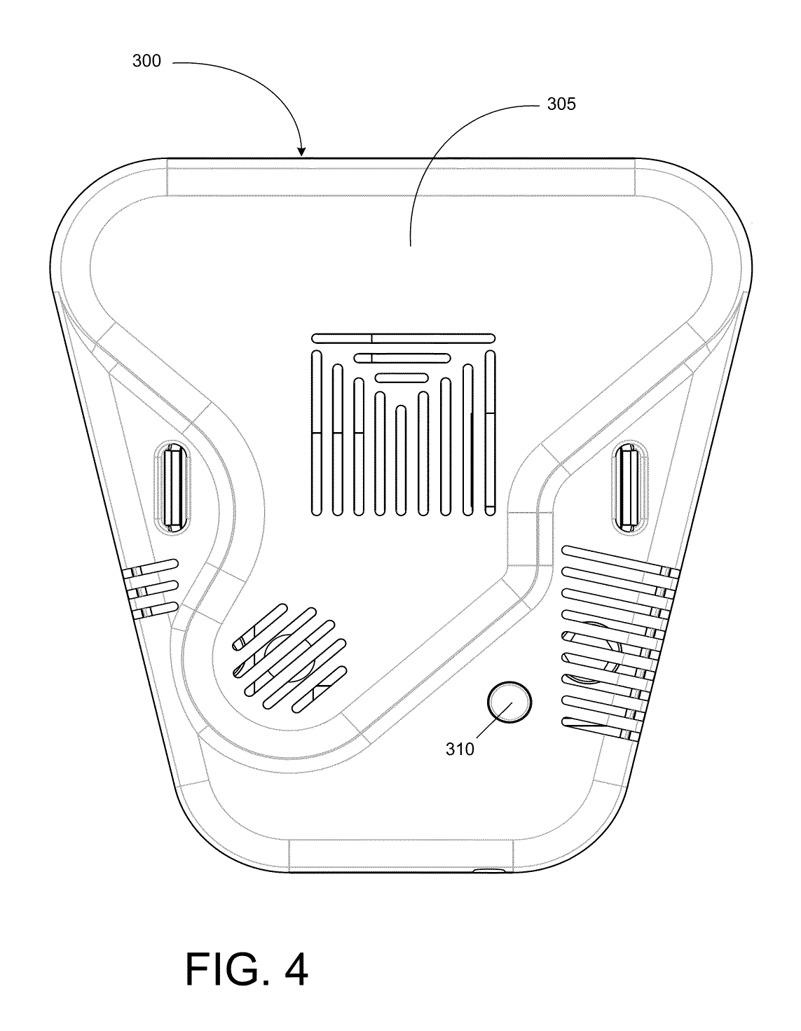

FIG. 2, which includes sub-part FIGS. 2A and 2B, illustrates an overall operative relationship of an example of the present developments in charts 50a and 50b. The control panel 20 from FIG. 1 would include control circuitry 20a as shown for example in chart 50a of FIG. 2A, as this would be attached to the carbon monoxide detection system 30 and to a normally closed switch 15, this normally closed switch connecting then to the gas appliance 40 (note, this switch 15 or another, not shown, could then also connect to the additional or alternative device 40a from FIG. 1, as well). The carbon monoxide detection system 30 in this example, includes a first sensor 32, a second sensor 34, noting that the first and/or second sensors and the carbon monoxide detector system may be mounted on a plenum 36 and/or on an appliance 40 (see e.g., the black box schematic representation 36/40 in FIG. 3) or on a cold air return duct, not shown. The first sensor 32 is disposed to read a sample from ambient air. The second sensor 34 is disposed, as for example in or adjacent to, or otherwise connected in a closed circuit with an air stream in a plenum 36 to read a sample from air stream from an appliance 40. An alarm 28 and an alarm off and/or reset button 26 (this may be one or more buttons or other toggle or switch devices schematically represented by button 26 here) may also be attached to the control circuitry 20a.

The control circuitry 20a is configured or adapted so as to be able to set, trigger and/or maintain a switch connected to the gas appliance in either an on or an off state (e.g., by placing and/or maintaining a normally open switch in an open position so that a gas appliance may be turned or kept on; and vice versa, by switching such a normally open switch to the closed position to turn off, or maintain in the off position an appliance; note, a normally closed switch could be used here as well). In chart 50b, an exemplar switch is disposed in an open position by operation 15a, and an appliance is turned or maintained in an on operational disposition per operation 40a (these operations 15a and 40a may be discrete operations or a single operation indistinct one from the other). Control circuitry 20a, by and through sensors 32 and 34, is adapted to receive a sample from ambient air (sensor 32; operation 22, chart 50b) and a sample from an air stream (sensor 34; operation 24, chart 50b). The control panel 20 also features an off and/or reset button 26. When pushed, the off button 26 will silence an audible alarm 28, as shown by the audible alarm silenced box 26a. An alarm reset 26b may also optionally be included and/or needed. The alarm and the appliance may be triggered together or separately. For example, once the audible alarm is silenced, the gas-powered appliance 40 may be configured to remain in a non-operating condition until a qualified licensed technician inspects the source of carbon monoxide and approves the re-newed operation of the unit. In one implementation, if the audible alarm remains silenced for a period of time, e.g., 24 hours, after the off button 26 is pushed, the audible alarm may sound again after the period, e.g., 24 hours, has elapsed, as a reminder.

An operation to sense carbon monoxide, per operation 60, chart 50b, by the carbon monoxide detector system 30, may involve either or both of sensors 32, 34. If carbon monoxide is not detected, option 62, then the system will not take different action and the normally closed switch remains or will be maintained in a closed position, flow line 70 and operation 15a (operation 15a is either or both an initiating action to turn on the appliance, and/or a maintaining action or loop). When, in this primary implementation alternative, the normally closed switch is closed and remains closed, the gas powered appliance would continue its normal operation 40a, and the appliance 40 can remain on. Note, the loop, flow line 70, is figurative or schematic and need not indicate an affirmative communication during this maintaining of the operation of the appliance; it may merely be that no new action takes place while there is no sufficient level of CO detected by either of sensors 32, 34.

If, on the other hand, carbon monoxide is detected, per option 64, chart 50b, then an audible alarm 28 may be indicated to sound, per operation 80. Also, the normally closed switch is opened, operation 90. This action would break the circuit and disable the appliance putting it in off position, see operation 120. The switch may remain open until it is reset, automatically 100 (as by reduction of CO levels), or alternatively, the switch may be reset manually 110 (both automatic and manual resets are shown schematically within the single optional box/operation 100/110 in FIG. 2B), after which the normally closed switch is again closed per the loop back to operation 15a. Note, the optionality of box/operation 100/110 (dashed line forms) is indicated in that this may be a discrete step or operation, or it may not actually be discernibly different or discrete from that of the closing of the normally closed switch operation 15a. It may also be that, optionally, no reset is readily provided, as for example, when it may be that an appliance failure will be significant enough that no reset should be provided (hence, the dashed line form of the loop from 100/110 back to 15a).

Alternatively, or in concert with the above process, the carbon monoxide detector may be integrated with any of a number of separate devices for the purpose of preventing exposure to carbon monoxide. For example, the carbon monoxide detector may be connected to a wired or wireless extra alarm for more warning coverage. The carbon monoxide detector may also be connected to a garage door, and when the carbon monoxide levels reach certain predetermined thresholds the carbon monoxide detector may be disposed to signal or otherwise provide for the garage door to open. It may also be connected to one or more gas cutoff valves, to cut off the gas supply to an appliance at the detection of a threshold level of carbon monoxide. Moreover, an external device such as a fan or motor could be connected to or integrated with and activated or deactivated by the carbon monoxide detector device or system, as for example, to vent or pull air from the building and thus create an additional safety feature of the present developments. Generally speaking, any building or household device which may have its power circuit completed by triggering a switch or relay by the carbon monoxide detector, thus completing or disconnecting the power supply circuit to the separate device, may be integrated with the carbon monoxide detector and made operational, or deactivated, upon attainment of a certain threshold of carbon monoxide.

In FIGS. 3 and 4, a carbon monoxide detection device 300 according to an example hereof is shown including a cover 305, a push button 310 which when assembled extends through the cover 305. In FIG. 3, a control circuitry board 320, attachment screws 330a, b, c, and d, a rear plate 340, and a sampling tube 350 are also shown. When assembled onto a gas powered appliance 40 or plenum 36 or air stream therefrom as may be in a plenum or cold air return duct attached to or otherwise being schematically represented/depicted by box 36/40, the carbon monoxide detection device may be configured to shut off the gas powered appliance when the threshold reaches a predetermined level. A first carbon monoxide sensor 360 may be mounted on a control board with air holes in the bottom half of the outer cover to detect carbon monoxide that may be coming out of the appliance or plenum that is in the air stream of a forced air gas furnace. The second carbon monoxide sensor 370 may be mounted on the control board with the outer cover over it and a divider in the middle separating the top from the bottom, so it senses carbon monoxide in ambient air as such may be otherwise emanating from the appliance or otherwise appearing. As introduced, the carbon monoxide detector may be mounted on a plenum or cold air return duct, as for example generally depicted by appliance box 36/40. This carbon monoxide detector 360 may sense the air from the air stream by a sampling tube 350 that may be installed directly into the air stream or plenum. There may also be a second, smaller tube (not shown in FIG. 3) installed in the plenum to provide for the air to flow in to the sampling tube, over the second carbon monoxide sensor 360, and back into the plenum or air stream. A cover (also not shown in detail in FIG. 3) over the second carbon monoxide sensor 360 may be disposed to keep the air from the plenum separate from the ambient air in the room. The detector would typically or most often have such a sampling tube on or connected to it when it is in use with a forced air gas furnace. If it is in use with a boiler, powered water heater, or other gas powered appliances, the sampling tube may not be installed, as there would typically thus be no plenum or cold air return duct or air stream.

The carbon monoxide detector may, in an example, be set at 50 ppm or more for initial alert, or it may be on delayed alert with several different timing or operational level options. The different timing options may be adjustable by dip switches or other switches. For example, time settings for the alert may be 5 minutes, or 15 minutes, or 25 minutes, or 35 minutes or more. Once a desired threshold level, as for example, of 50 ppm, or more of carbon monoxide is detected by the carbon monoxide detector, an audible alarm would be disposed to sound to let those in the vicinity know that carbon monoxide has been detected. Simultaneously or within a discrete period, the appliance that the carbon monoxide detector is installed on may be triggered by the system/device 30/300 to shut down, and thus no longer emit carbon monoxide.

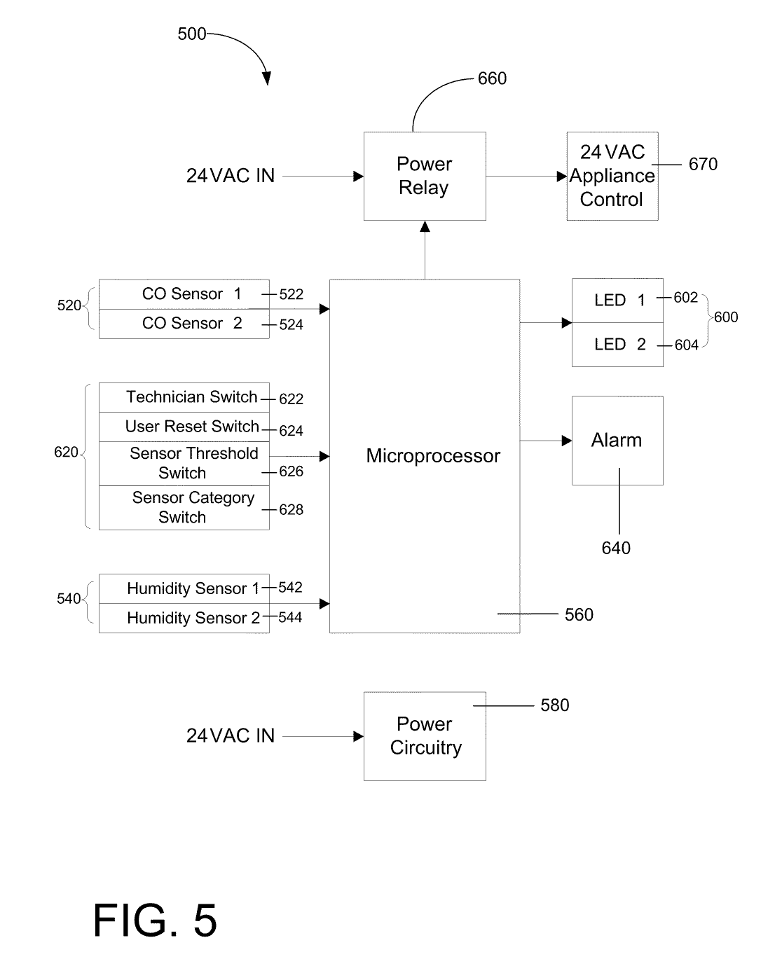

With respect to the control board 320, the operating power, or the control board power, may be 24 volts AC (alternating current). Batteries may alternatively be used, or in many implementations, may not be necessary in the detector, so long as the sensors produce a current or resistance per ppm of carbon monoxide. There may be dip switches, for example, four dip switches, on the control board 320 to adjust the sensitivity and the timing of the alarm response. The appliance 40 may be wired in series with the switch 15 (not shown in FIGS. 3 and 4, but see also relay 660 in FIG. 5). When the switch opens it breaks the circuit, thus turning the appliance 40 off. A diagnostic light may also illuminate in the sensed condition together with the alarm and/or shutting down of the appliance. A light might depend upon which sensor reads carbon monoxide and opens the switch. There may be one light per carbon monoxide sensor, so the origination of the carbon monoxide is known. Or, lights may be provided, as for example, green for a below threshold CO level, and red, e.g., for a greater than threshold CO level. Once either sensor reads the threshold, as for example, the 50 ppm to 70 ppm of carbon monoxide, the switch may be energized and stay open until manually reset.

The switch may be reset by depressing a button, such as button 310 on the control board 320, allowing the appliance to operate for further testing. The detector may also sound an audible and/or visible alarm 310 to warn the home owner of the carbon monoxide problem. In some implementations, the audible alarm may be turned off by depressing a button 310 on the control board 320, but the switch may be configured to stay in the open position keeping the appliance off until a technician has checked the appliance and determined it acceptably operable. If the 24 volt power supply is disconnected and reenergized, the control board may stay in the default mode, keeping the appliance off. The control board may also have a timer (not specifically shown/identified in FIG. 3) in it to track the life of the sensor. Once the sensor reaches the end of its life, the audible alarm may sound.

The button 310 may be adapted to also be pushed for a period, as for example of at least 4 seconds, so as to set it in test mode to verify proper operation and functions of the carbon monoxide detector. In the test mode, the audible alarm may sound.

The carbon monoxide sensor may produce a current or resistance for a distinguishable amount, e.g., every 1 ppm of carbon monoxide it detects. The control board may change the current or resistance that the carbon monoxide sensor produces into a current that can control the switch.

The sampling tube 350 may be short 390 if connected relatively directly via a hole or holes 380a,b of a plenum/appliance/cold air return duct 40; or in some instances, the sampling tube may be longer, as for example, a 20 inch piece of 0.5 inch metal conduit or electrical metal tubing (not shown in FIG. 3), with a 0.25 inch hole, e.g., approximately every inch along the pipe. The sampling tube may have a plug at the end of the pipe or it may be crimped to seal the pipe so that it is drawing air through the 0.25 inch holes. The sampling tube may be cut to fit into the desired plenum/appliance 40. A second sampling tube (not shown in FIG. 3) may also be used either for return of the air stream or for other testing; this may also be a 0.5 inch piece of metal conduit or electrical metal tubing approximately two inches long. The sampling tube 350 may be installed to create a draft through the sampling tube from the plenum 40. The sampling tubes may be connected to a threaded conduit fitting. The threaded conduit fitting may connected to the back of the carbon monoxide detector with a nut to go over the threads of the fitting.

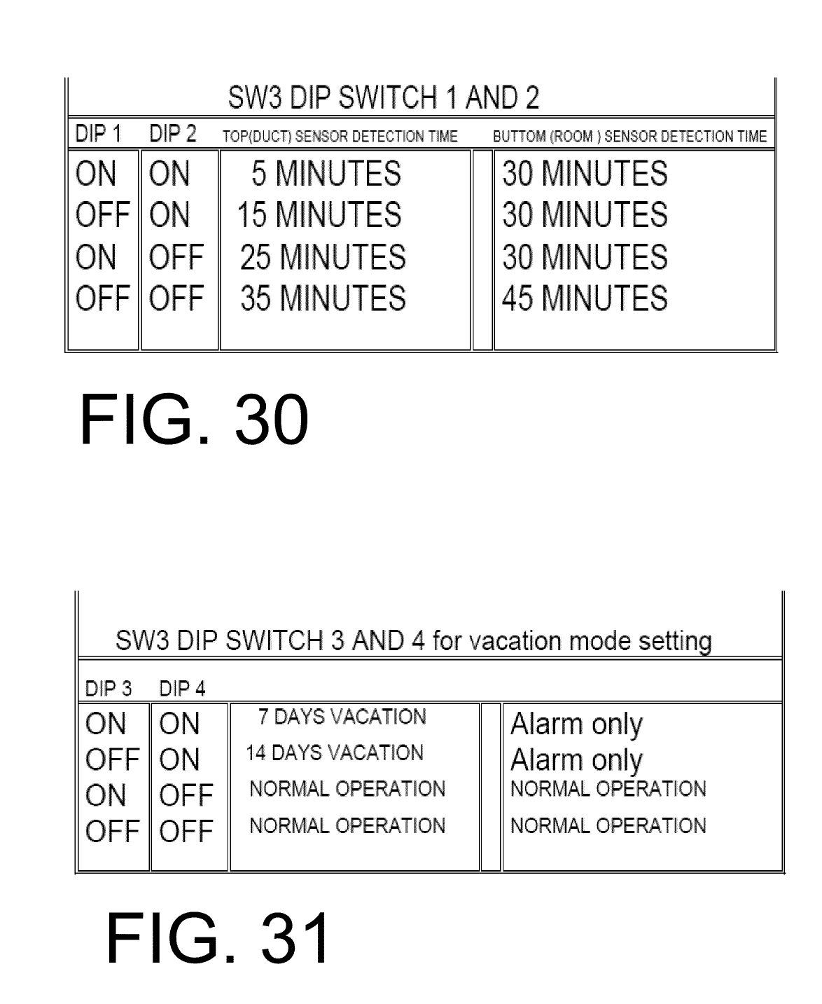

The carbon monoxide detector may be installed on the plenum or cold air return duct of a furnace may be by using the back cover 340 of the carbon monoxide detector as the template for the holes on the plenum. Holes 380a and/or 380b, e.g., may be drilled on the plenum, in some examples to ¾ of an inch deep; the template holes may be only ½ of an inch. The template may be used to center the holes. Tin snips may be used to notch out a slit for the screw on the EMT connector. A 20 inch long tube may be slid into the EMT fitting, and secure the tube with the screw from the fitting. The holes in the tube should be facing down, or up, or sideways, or facing the air stream. The 20 inch tube may be cut it to fit any plenum by cutting the non crimped side and cutting off as little as possible for a larger sampling area. A 2 inch long tube may be slid into the fitting, and secured with the screw on the fitting. Both of the EMT connectors may be mounted to the back cover of the detector by putting the threaded part through the outside and into the inside of the detector. A nut may be used to fasten the fitting to the cover. The tubes may be slid into the holes previously drilled in the plenum, and the detector may be secured by screwing the back cover to the plenum. The sensor may bear a letter that will indicate which of the sensor grouping a dip switch diagrams, as shown in FIGS. 30 and 31, e.g. (described below), should be used for proper placement of the dip switches.

For installation of the carbon monoxide detector on a boiler, tubes are not necessarily needed. The back cover may be mounted to the boiler or wall of the mechanical room by screwing it to the surface. If mounting on the wall of the mechanical room, it may be placed by the exit as high as possible. The sensor may bear a letter that will indicate which of the sensor grouping a dip switch diagrams, as shown in FIG. 30 or 31, should be used for proper placement of the dip switches.

To wire the carbon monoxide detector, the detector may have four or more terminals, R, C, IN, and OUT. The R terminal may be the 24v power supply to the carbon monoxide detector. The C terminal may be the 24v common to the carbon monoxide detector. The IN terminal may be one side of the normally closed switch. The OUT terminal may be the other side of the normally closed switch. The switch would open when the carbon monoxide detector senses carbon monoxide.

For wiring a furnace, power to the furnace should be disconnected. The wire that hooks up to the THERMOSTAT AT THE FURNACE, often the Red wire, on the terminal, often the Red terminal (on older furnaces the Red wire may hook up to the Transformer), or the Red wire that hooks up to the THERMOSTAT AT THE FURNACE on the R terminal (on older furnaces the RED wire may hook up to the gas valve or transformer) should be disconnected. New thermostat wire should be run from the furnace to the carbon monoxide detector; wire R from the Furnace to the R terminal on the carbon monoxide detector; wire C from the Furnace to the C terminal on the carbon monoxide detector; wire W or R from the Furnace to the IN terminal on the carbon monoxide detector; wire from the OUT terminal on the carbon monoxide detector to the W or R terminal to the thermostat, which was previously disconnected. The carbon monoxide detector may be put in operation mode by turning the furnace power back on. The carbon monoxide detector may be put in test mode by pressing the button 310 for a preset period, as for at least for 4 seconds, after which the alarm may sound. The carbon monoxide detector may also have an initial self test mode which will ensure the detector is working properly. When replacement of the carbon monoxide detector is needed, an alarm may sound, and replacement of the carbon monoxide detector may be scheduled by the user.

For wiring a boiler, power should first be disconnected to the Boiler. A new thermostat wire may be run from the boiler to the carbon monoxide detector. Wire may be run from the hot leg of the secondary transformer to the R terminal of the carbon monoxide detector; from the common side of the secondary transformer to the C terminal on the carbon monoxide detector; from one of the T terminals on the boiler to the IN terminal on the carbon monoxide detector; and from the OUT terminal on the carbon monoxide detector to one side of the end switch. If there is not an end switch the latter may be wired it to the R terminal on the thermostat. The carbon monoxide detector may be put in operational mode by turning the furnace power back on. The carbon monoxide detector may be put in test mode by pressing the button 310, for a pre-set period, as for example, at least for 4 seconds, after which the alarm may sound. The carbon monoxide detector may also have an initial self test mode which will ensure the detector is working properly. When replacement of the carbon monoxide detector is needed, an alarm may sound, and replacement of the carbon monoxide detector may be scheduled by the user.

FIG. 5 illustrates a general schematic version of a circuit, which includes CO sensors 520 (522 and 524), humidity sensors 540 (542 and 544), a microprocessor 560, power circuitry 580, LEDs 600 (602 and 604), switches 620 (622, 624, 626 and 628), an audible alarm 640, and a power relay 660. The relay 660 is connected to the microprocessor and to the appliance control 670 to maintain the appliance on or turn it off.

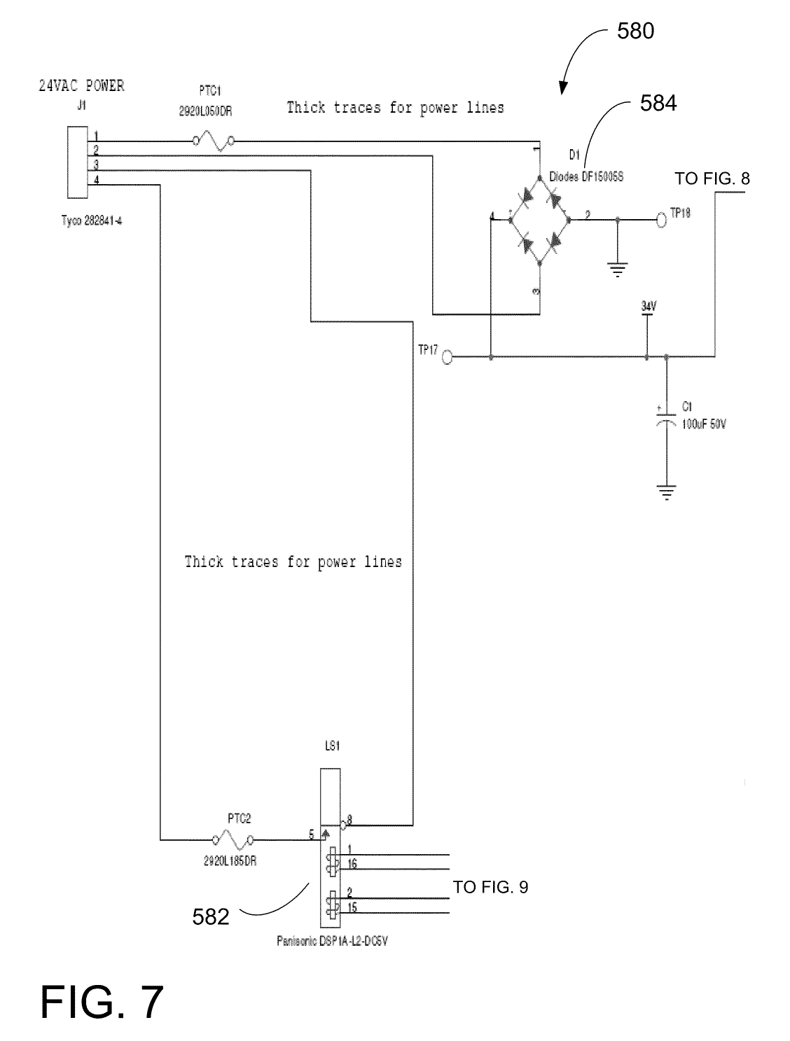

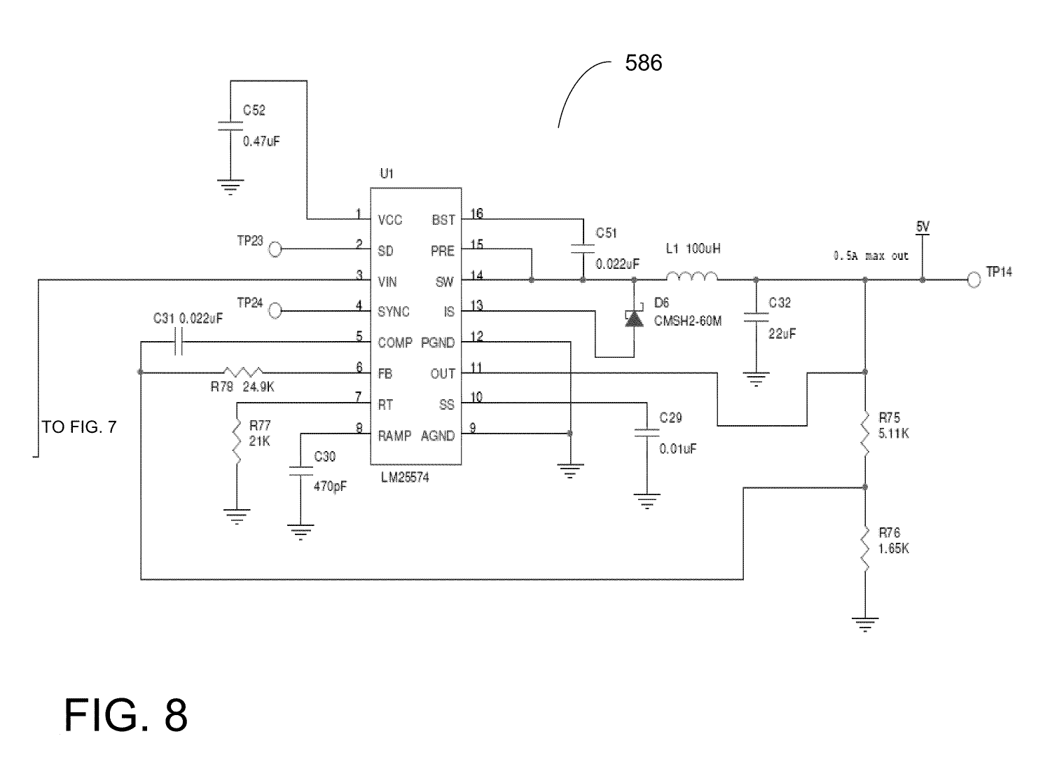

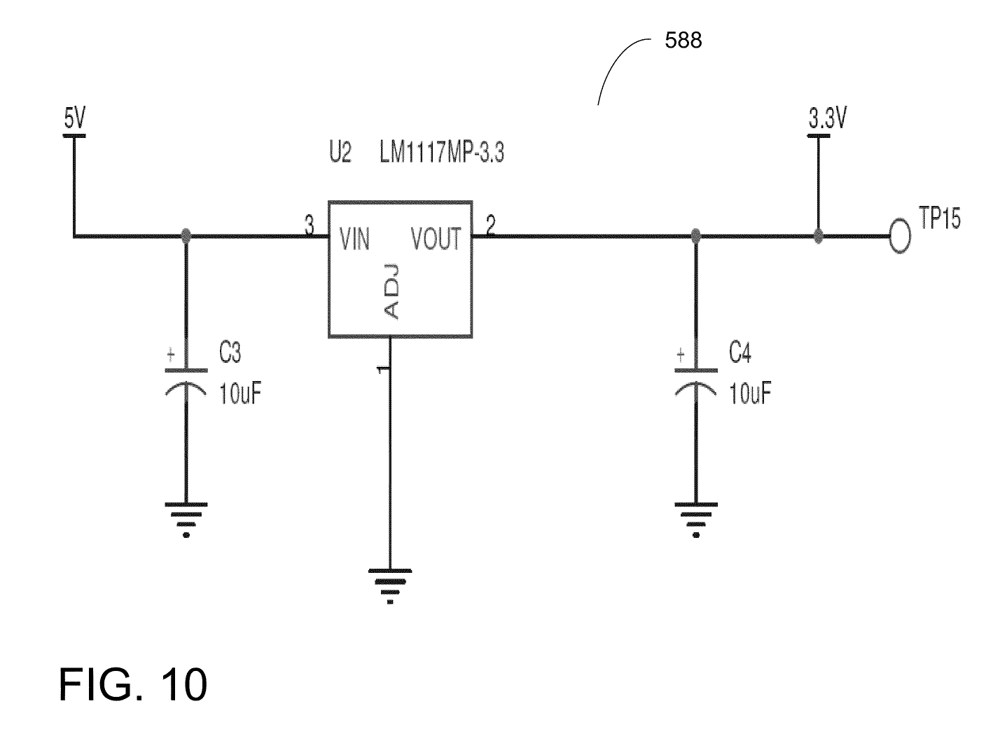

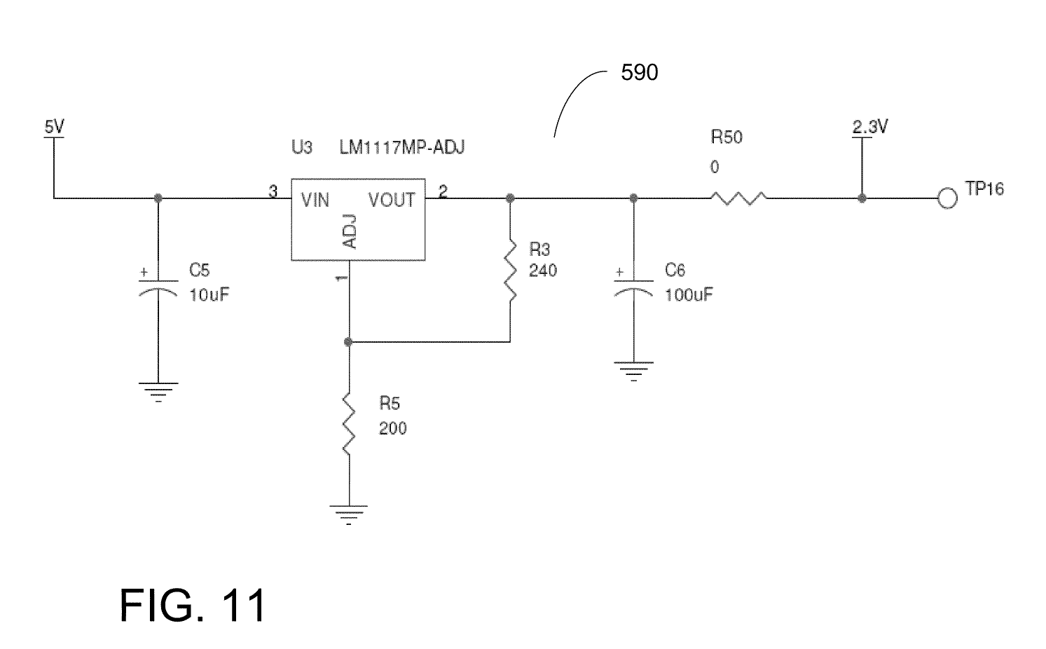

As shown in FIGS. 7-11, the power circuitry 580 may include a power transformer 582 (with associated circuitry 582a), a bridge rectifier 584, and three voltage regulators 586, 588, and 590. The power transformer 582 may isolate the 24VAC from the circuit board via power relay to the microprocessor. The bridge rectifier 584 may convert the AC voltage to DC voltage. A first voltage regulator 586 may convert the 12VDC to 5VDC. A second voltage regulator 588 and third voltage regulator 590 may convert 5VDC to 3.3VDC and 2.3VDC, respectively. The 5VDC may be used for the alarm 640, CO sensors 520, and/or the power relay 660. The 3.3VDC may be used for the microprocessor 560, LEDs 600 and switches 620. The 2.3VDC may be used for the heater in the CO sensors 520.

The microprocessor 560 may evaluate voltage levels of the CO sensors 520. The voltage level may correlate to a corresponding CO level in parts per million. Based on the level detected, the microprocessor 560 may determine relative to a threshold if it needs to alert the customer and/or shut down the power. The microprocessor may monitor the switches 620 and take action based on their input. In one implementation, the microprocessor may be a Texas Instruments MSP430F133, available from Texas Instruments, Dallas, Tex.

The CO sensors 520 may be used to detect a threshold level, e.g., 10-70 ppm of carbon monoxide or more. 2.3VDC may be provided to the sensor heater 526. The CO sensors 520 may vary their resistance with different concentrations of CO. A voltage divider may be made with the sensor and a resistor to provide a varying voltage that is read by the microprocessor 560. In one implementation, the CO sensors 520 may be Applied Sensor AS-MLC available from Applied Sensor Ind., Warren N.J.

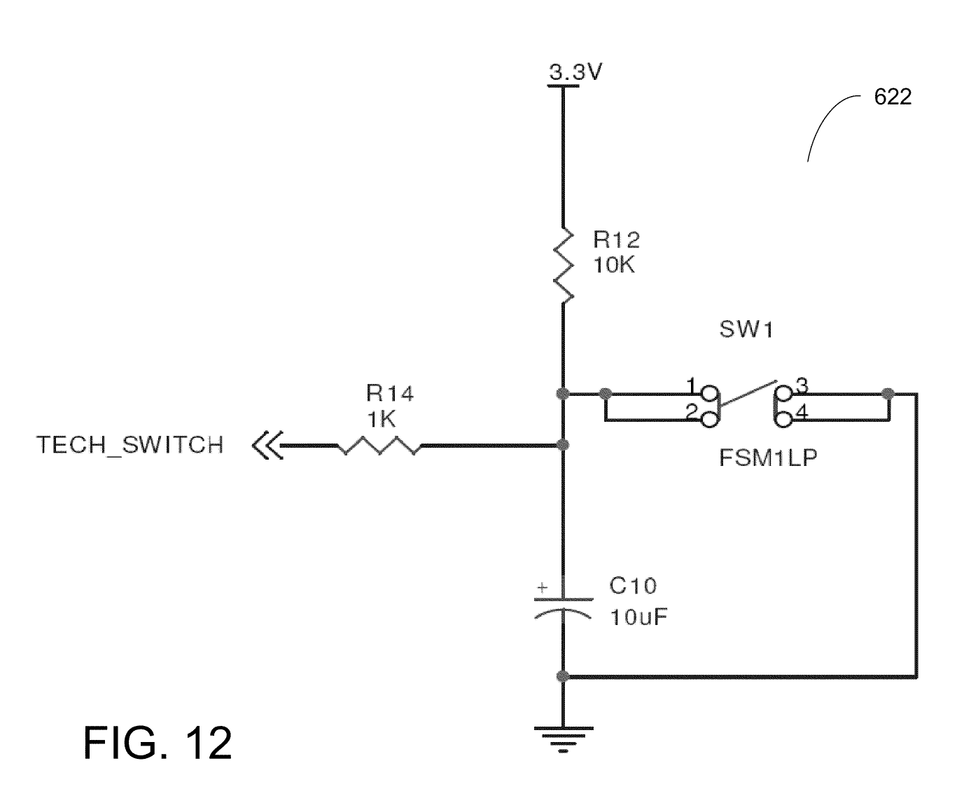

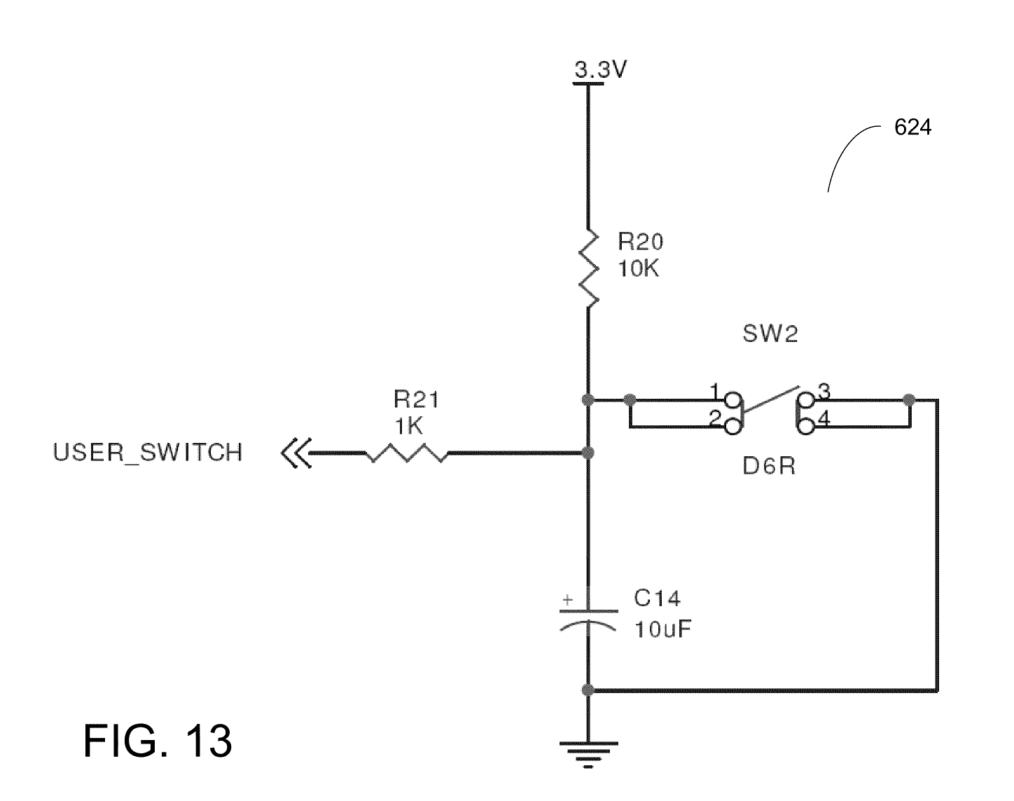

The switches 620 may include, as shown in FIG. 5, a technician switch 622 (see also FIG. 12), a user reset switch 624 (see also FIG. 13), a sensor threshold switch 626, and a sensor category switch 628. The switches 620 may also include, as switch types, a rotary switch and two push button switches. A rotary switch may be used to select the PPM CO trip threshold value. A position may be saved for a test mode (described below). A user reset switch 624 may be available for the user to reset the audible alarm 640, i.e., to turn off the alarm. The user switch 624 may, in some implementations also be used in test modes, e.g., it may be configured to be held to test the audible alarm 640. The technician switch 622 may be hidden to the user and allow a technician to reset the system after being tripped.

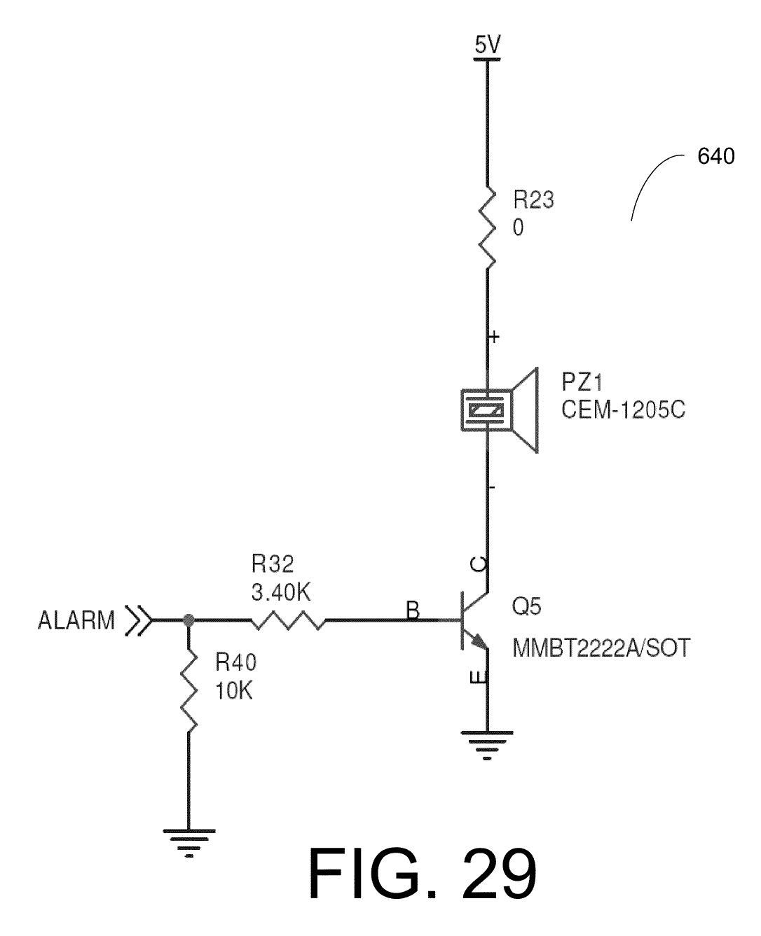

The alarm 640 (FIG. 29) may sound to alert the homeowner to a problem with the CO level when a threshold is tripped. This alarm 640 may be turned off with the user reset switch 624.

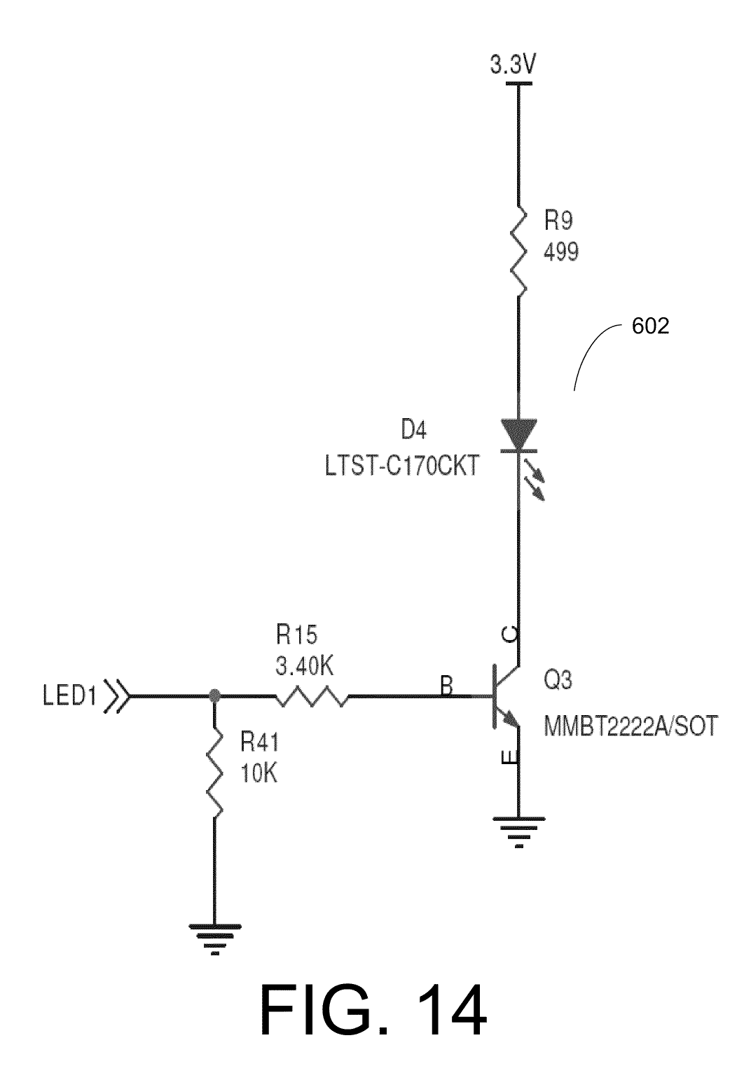

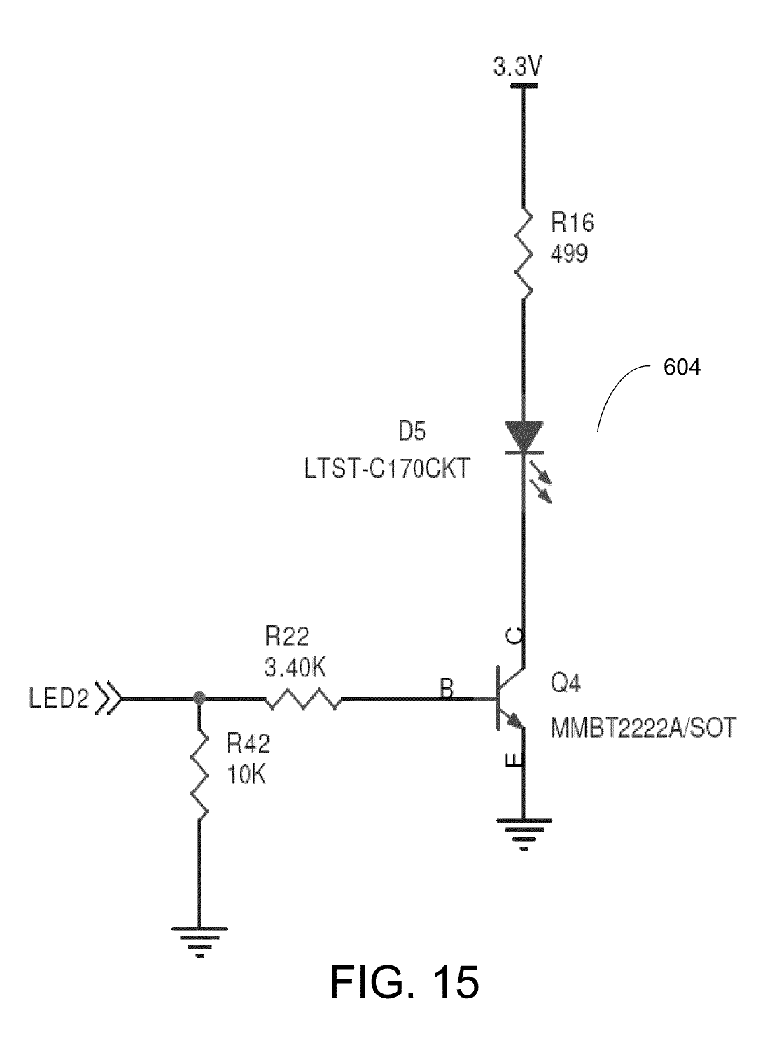

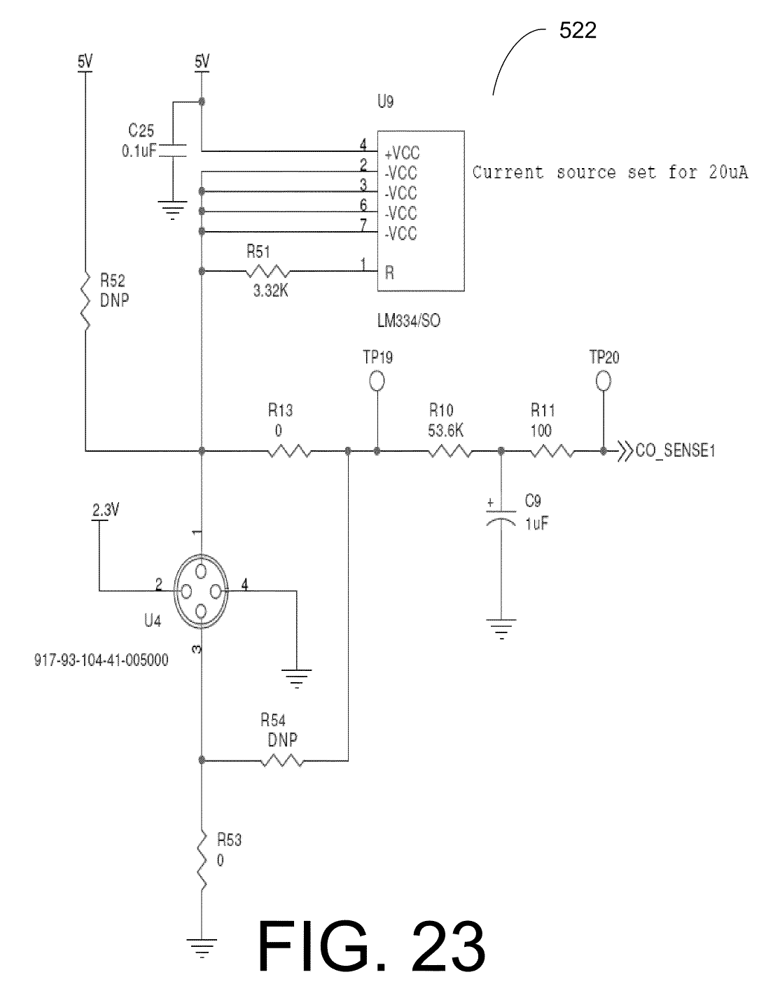

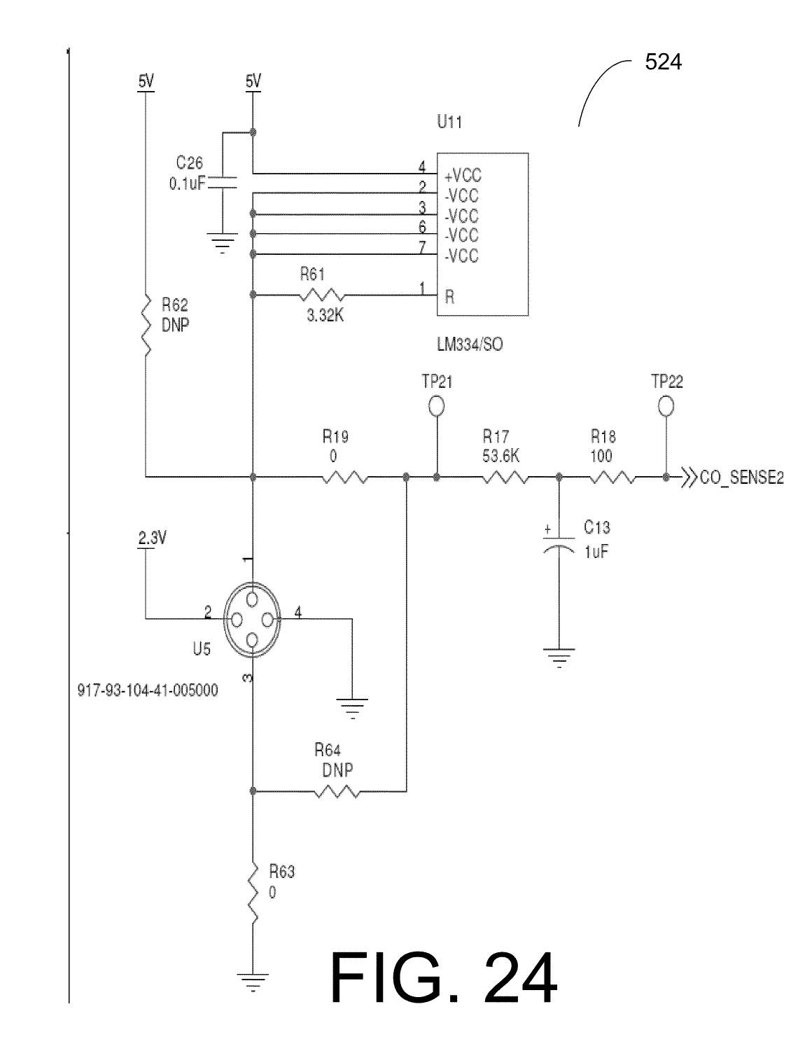

The LEDs 600 may include two LEDs, 602 and 604 (see also FIGS. 14 and 15), that correspond to the two CO sensors 522 and 524 (see also FIGS. 23 and 24). When a threshold is tripped the appropriate LED will light for its respective CO sensor, i.e., LED 602 (FIG. 14) may be adapted to light for CO sensor 522, and LED 604 (FIG. 15) adapted to light for CO sensor 524. The LEDs 600 may be configured so that they may only be reset with the technician reset switch 622.

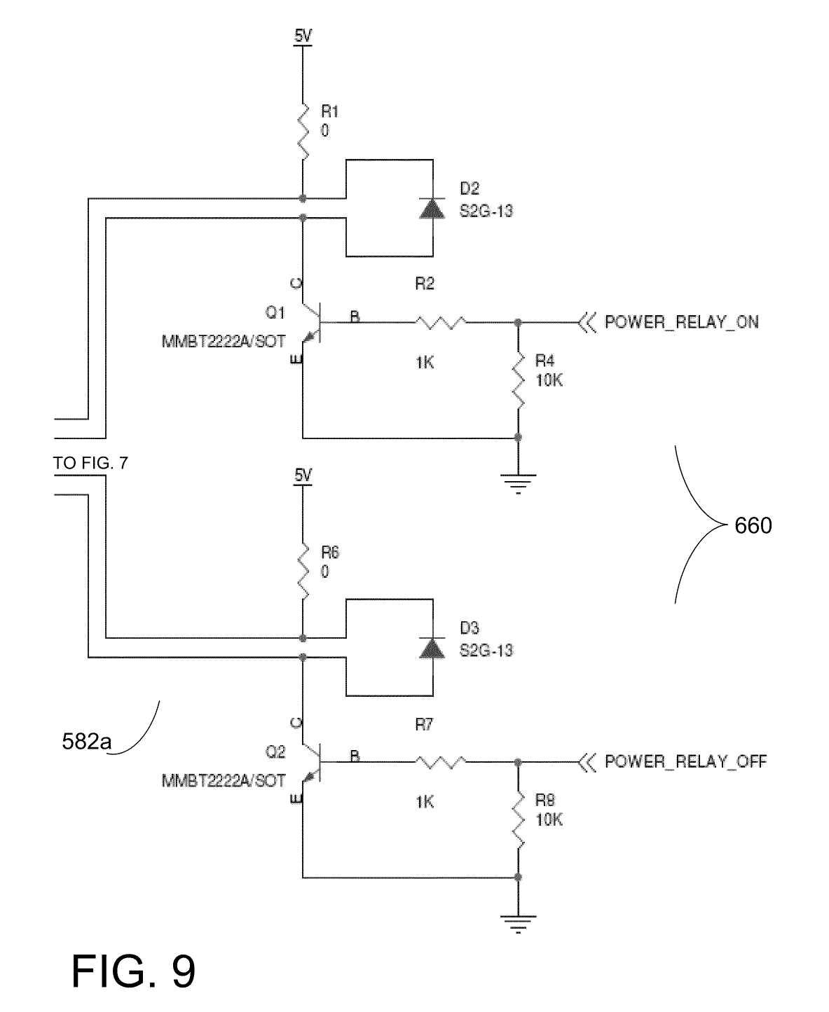

The power relay 660 (see also FIG. 9) may be adapted to control the 24VAC 670 that powers an appliance such as a furnace. The power relay 660 may be open, as in a normally open switch, and then closed when a threshold level is reached and the microprocessor signals it to be closed or tripped and then may be configured so as to only be reset when the technician switch 622 is pressed.

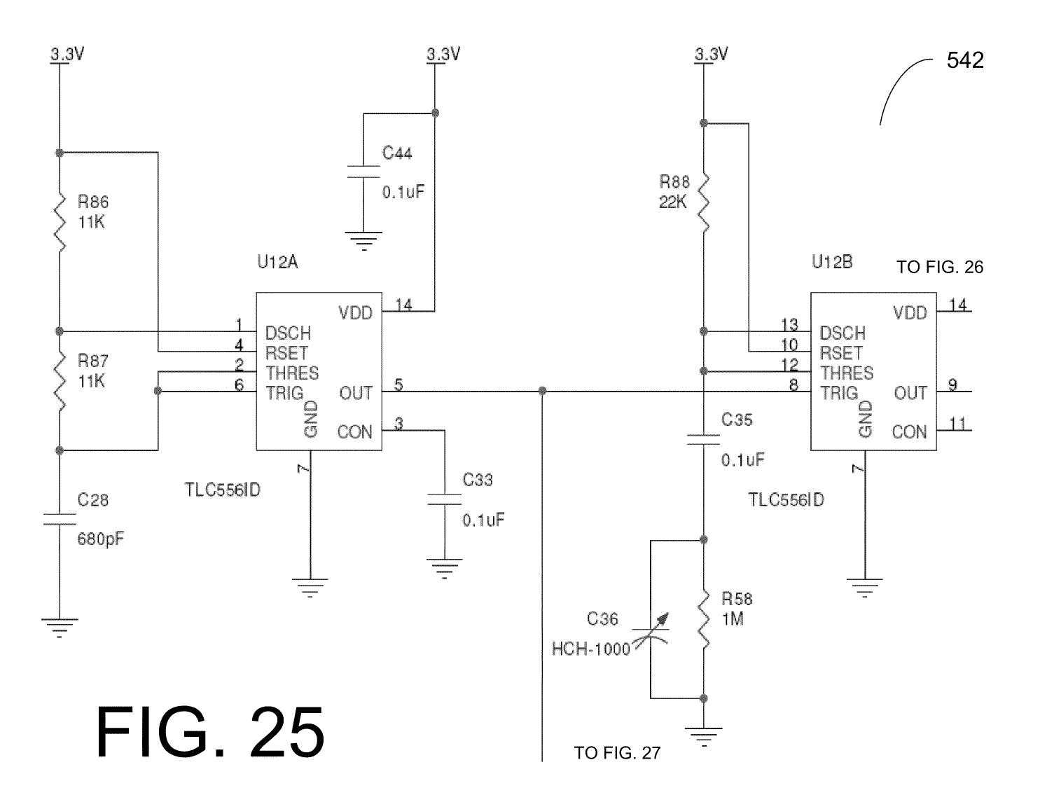

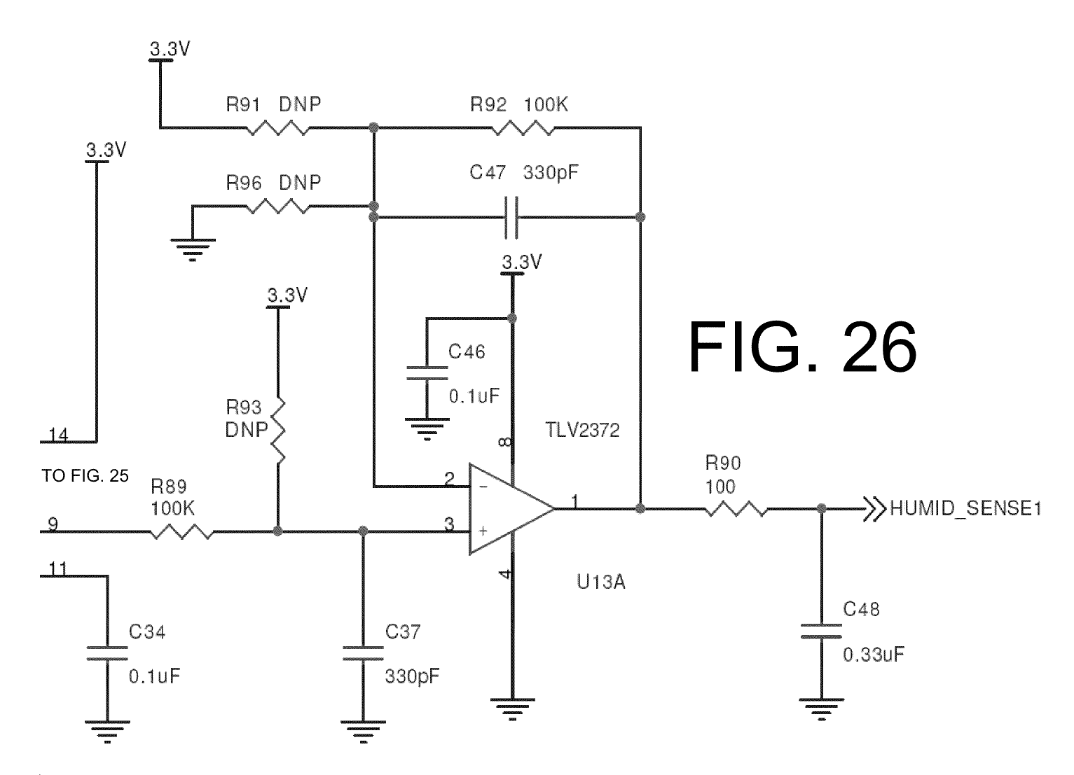

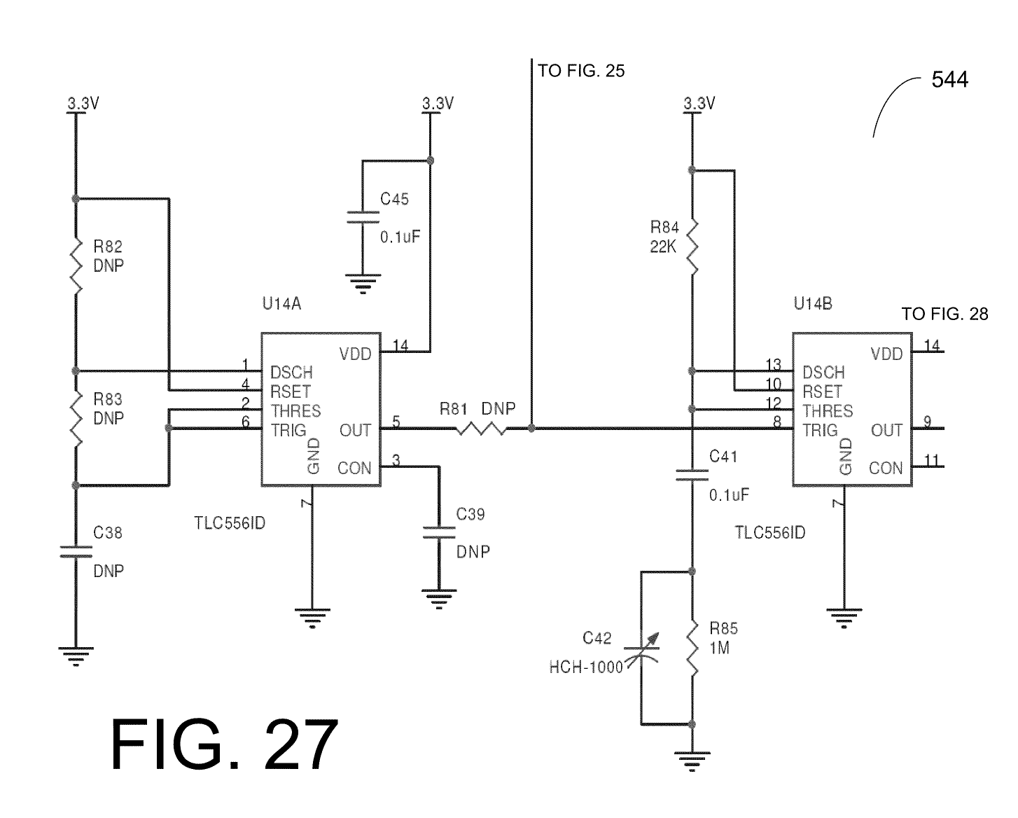

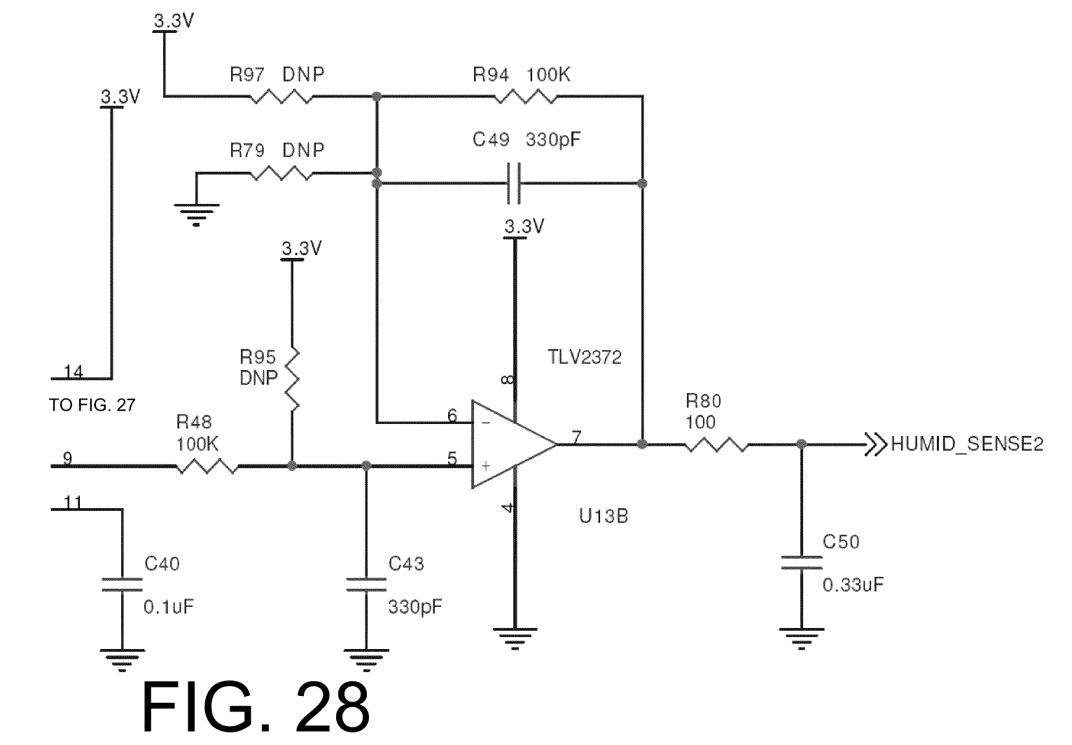

Humidity sensors may also be included to provide for calibration, or assist in better determining the CO level, inter alia. The humidity sensors 540 (542, 544 and see FIGS. 25-28) may be used to assist the CO sensors 520. Based on the humidity and CO sensor 520 resistance, a CO level may be determined. Indeed, a humidity sensor may be used to measure humidity first in order to maintain the accuracy of sensing carbon monoxide sensing; i.e., the carbon monoxide sensing accuracy may depend upon the level of humidity in the system, and thus an appropriate determination of the humidity can be used to effectively calibrate the CO sensor, or the results thereof to achieve an accurate CO level detection.

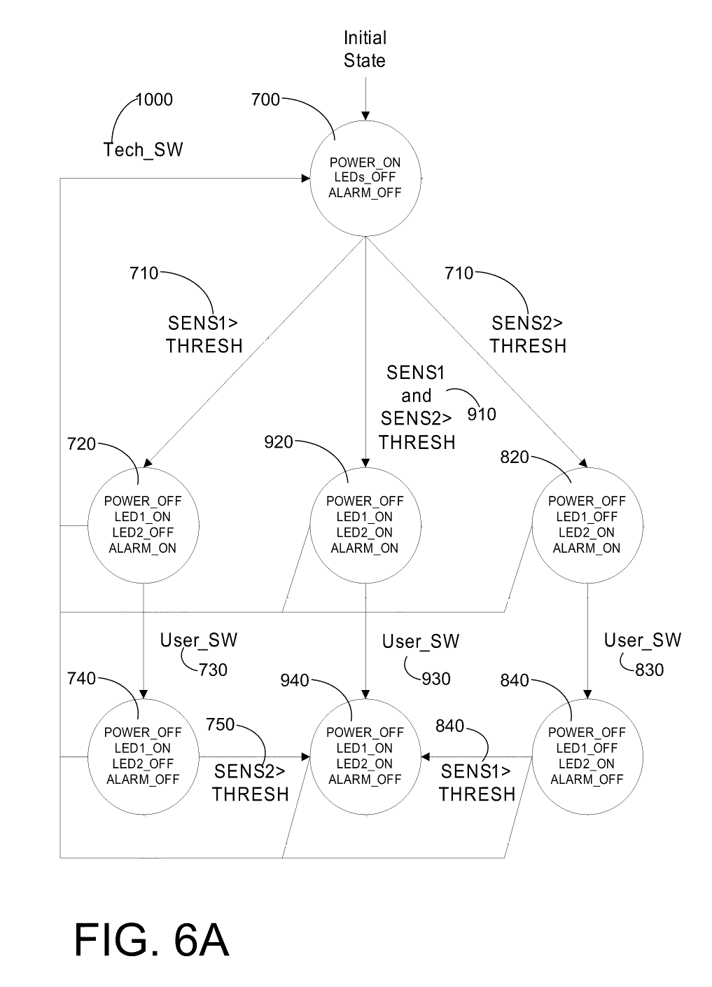

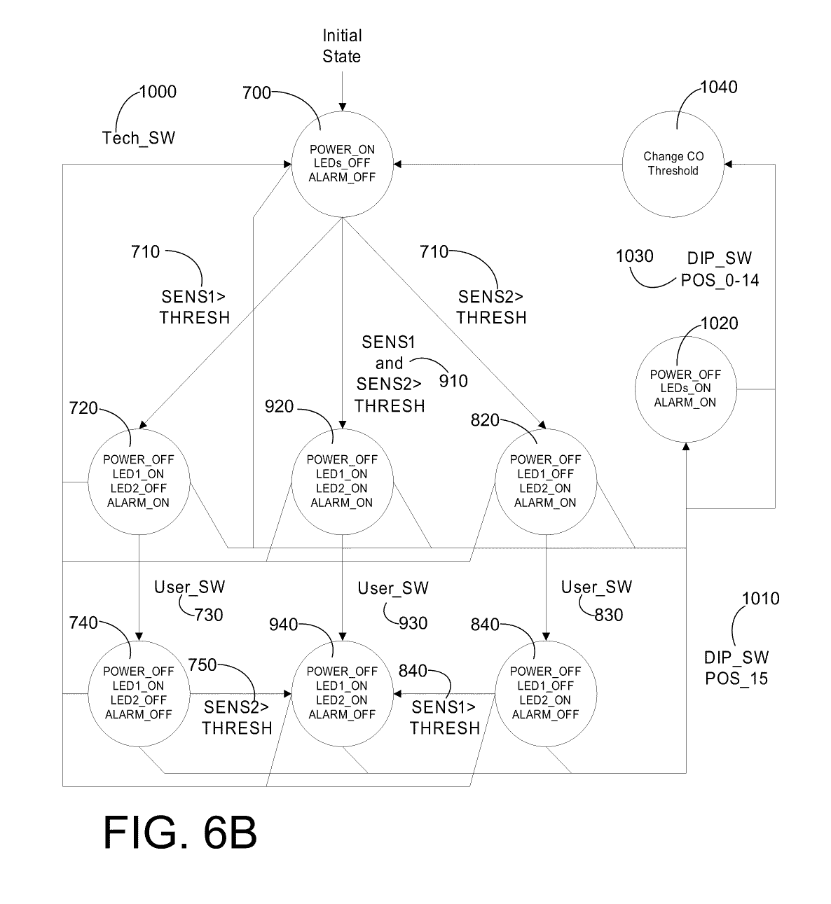

FIG. 6, which includes sub-part FIGS. 6A and 6B, provides state diagrams illustrating exemplar basic operations of the system software. As shown in both FIGS. 6A and 6B, but primarily in 6A, the system may have an initial state 700, wherein the power is on, the LEDs are off, and the alarm is off.

If CO sensor 1 exceeds the threshold, state 710, then the power is turned off, LED1 turns on, LED2 remains off, and the alarm turns on as indicated in state 720. The technician may switch off the power 1000, after which the system returns to its initial state 700. The user may switch off the alarm, state 730, after which the power remains off, LED1 remains on, LED2 remains off, and the alarm turns off as indicated in state 740. Thereafter, if CO sensor 2 exceeds the threshold, state 750, then the power will remain off, LED1 will remain on, LED2 will turn on, and the alarm will remain off, state 940.

If CO sensor 2 exceeds the threshold, state 810, then the power is turned off, LED1 remains off, LED2 turns on, and the alarm turns on as indicated in state 820. The technician may switch off the power state 1000, after which the system returns to its initial state 700. The user may switch off the alarm state 830, after which the power remains off, LED1 remains off, LED2 remains on, and the alarm turns off as indicated in state 840. Thereafter, if CO sensor 1 exceeds the threshold, state 850, then the power will remain off, LED1 will turn on, LED2 will remain on, and the alarm will remain off, state 940.

If CO sensor 1 and CO sensor 2 both exceed the threshold, state 910, then the power is turned off, LED1 turns on, LED2 turns on, and the alarm turns on as indicated in state 920. The technician may switch off the power, state 1000, after which the system returns to its initial state 700. The user may switch off the alarm, state 930, after which the power remains off, LED1 remains on, LED2 remains on, and the alarm turns off as indicated in state 940.

Thereafter, if a technician flips the technician switch, state 1000, the system may return to its initial state 700. Alternately, as shown in FIG. 6B, a test mode may be included. Here, the dip switch DIP_SW may be POS_{—}15, state 1010, leading to a state where the power is off, LED1 is on, LED2 is on, and the alarm is on in state 1020, i.e. essentially a test mode. Thereafter, if the dip switch DIP_SW is in POS_{—}1-14, state 1030, then the system can be configured to change the CO threshold, state 1040.

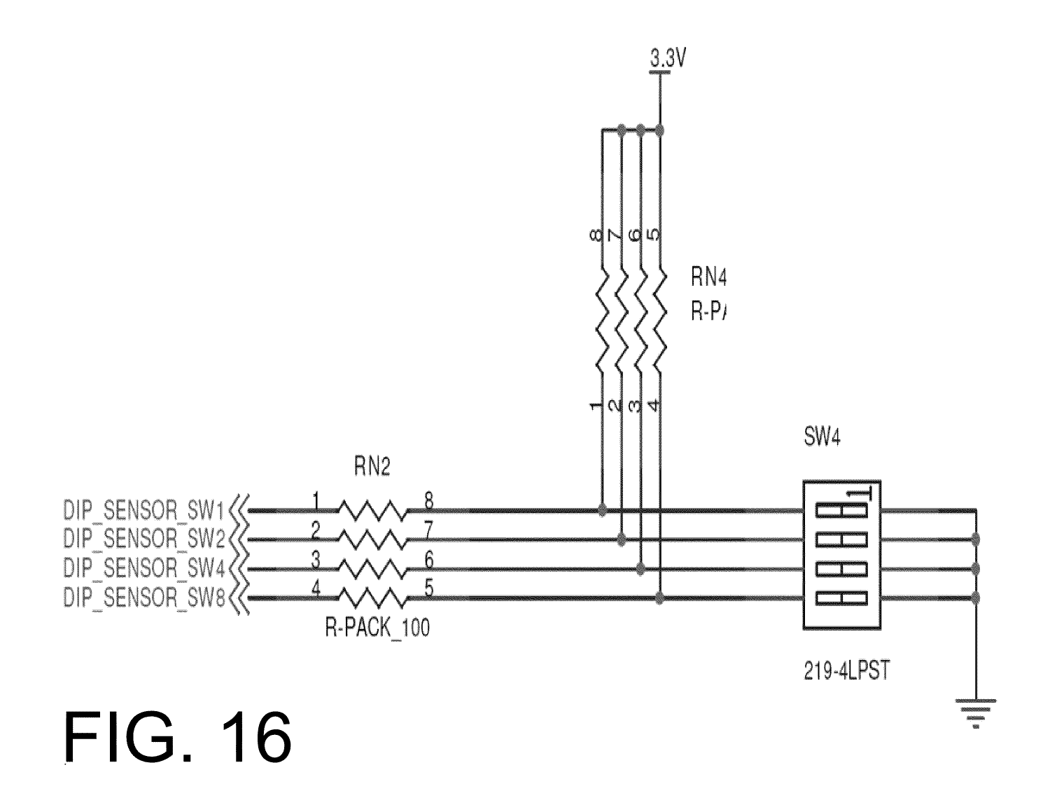

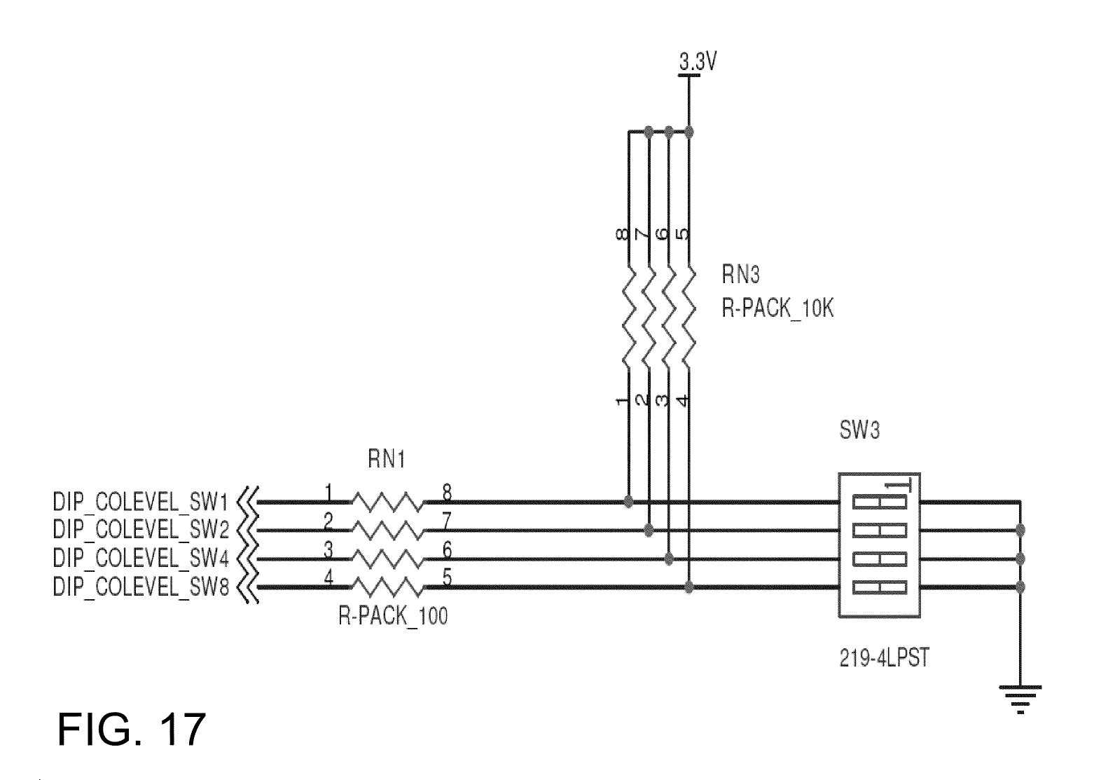

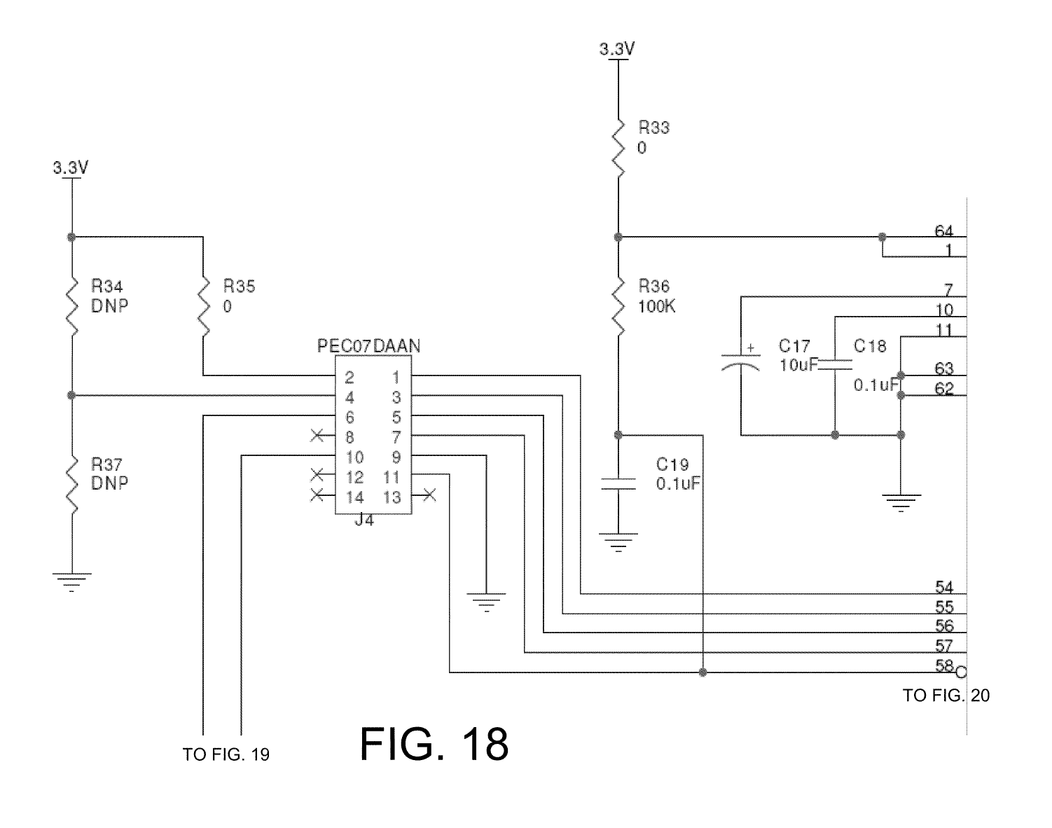

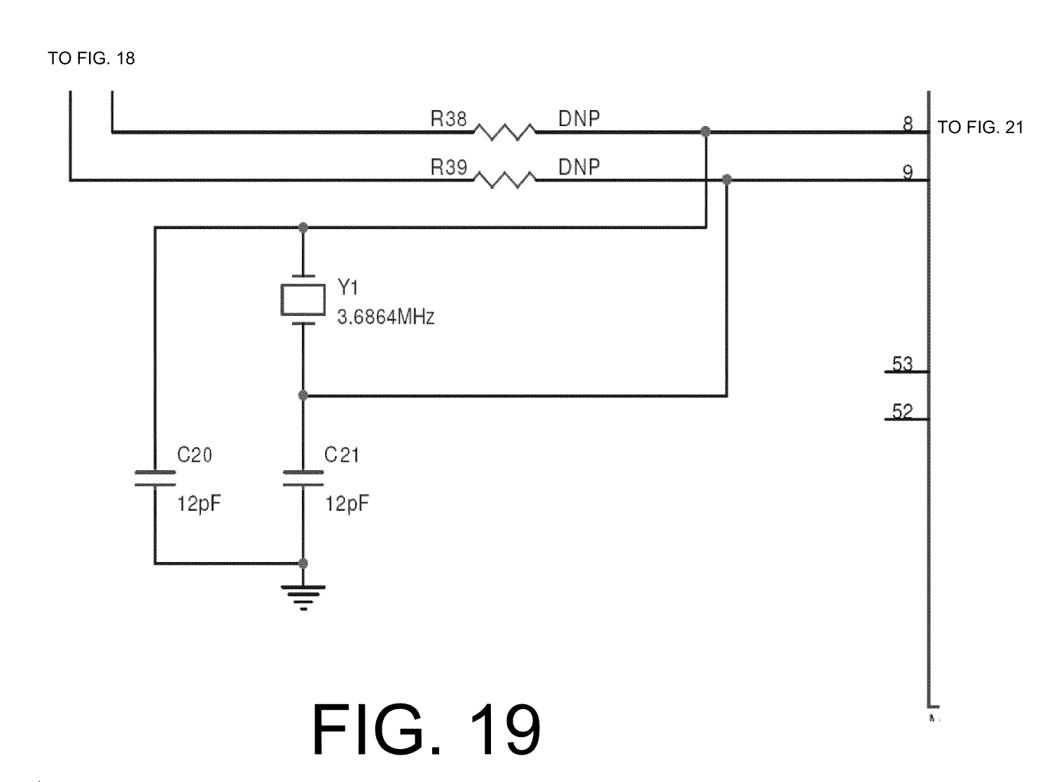

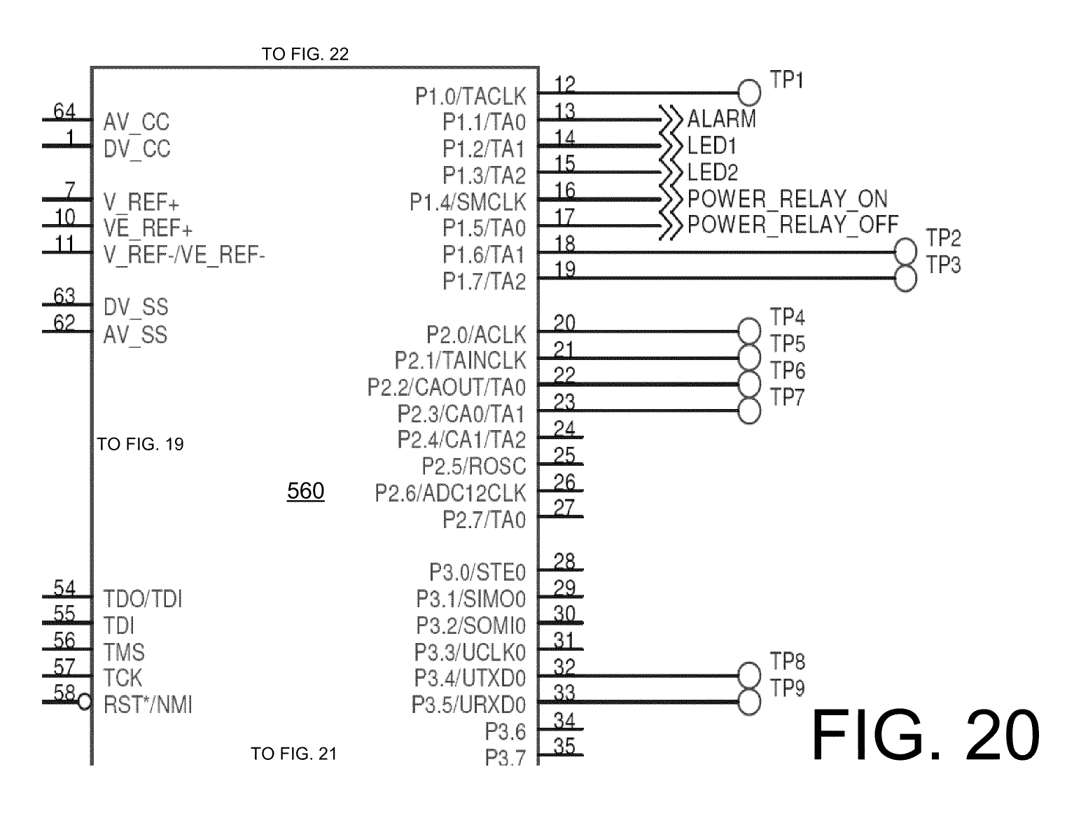

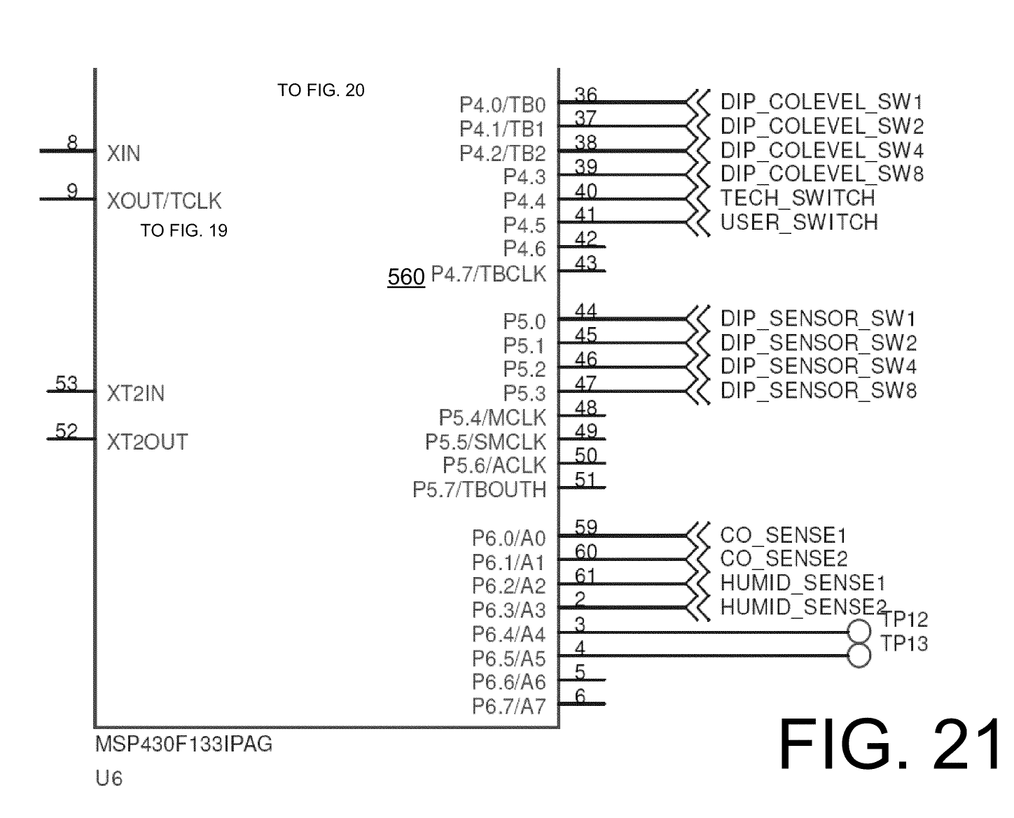

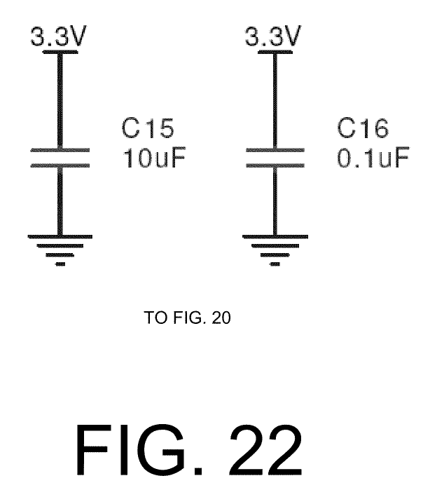

FIGS. 7-29, when read together, present a complete picture of an exemplar circuit diagram for use in/with the present developments.

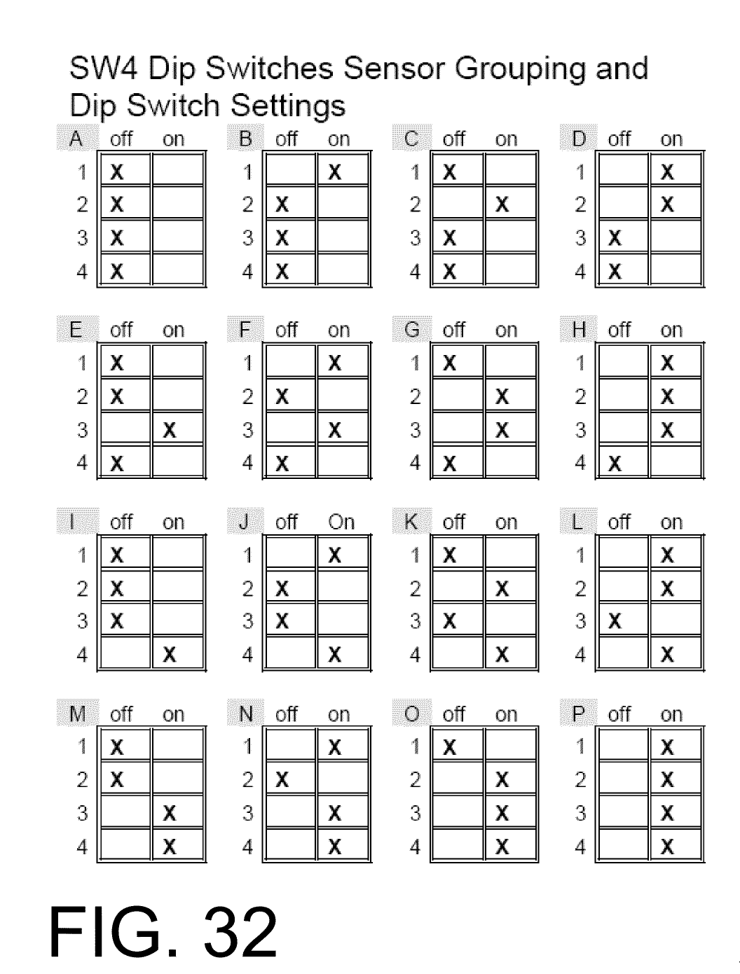

FIG. 30 illustrates some exemplars for the dip switch settings for SW3. FIG. 31 illustrates some exemplars for the dip switch settings for SW3 for the vacation mode setting, and FIG. 32 illustrates some exemplars for the dip switch sensor groupings and dip switch settings for SW4.

A device/system such as the devices/systems described above may thus provide a convenient and safe, and in some instances perhaps safer, ways to detect carbon monoxide and disable the source of the carbon monoxide before it reaches certain levels, and possibly remove carbon monoxide from a building. The ease of assembly and the ready availability of the materials to be used can be attractive features for an operator requiring a cost-efficient and effective means of detecting carbon monoxide in an enclosed space from a discrete appliance or number of appliances. A device/system hereof may be constructed from easily obtained materials in a rapid and efficient manner.

Markets for use hereof may include any indoor setting where gas appliances are installed and used, for example, homes, apartments, offices, or other places of work. Installation of such a device would improve the ability of the occupant or occupants of the building avoid carbon monoxide exposure by disabling the source of the carbon monoxide when ppms reach a predetermined threshold level, and also better enable occupants to assess the risk of exposure to carbon monoxide at lower and more discrete levels. Once the device is mounted onto or in association with a gas appliance, the device may operate without a battery, thus eliminating the problem of worn-out batteries in a typical carbon monoxide detector. The device may also be integrated with separate devices to assist in the venting of carbon monoxide from the building. The device may provide additional protection for people with certain health conditions, such as people with respiratory problems, or pregnant women. The device may also be used as a whole-building carbon monoxide detector.

As introduced above, a variety of alternative devices may implement the apparatuses hereof. Devices described herein may come in different forms. Thus, the sampling tube may be of dimensions other than those described hereinabove, and may be specially formed to be adapted to the individual gas apparatus. The lights or alarms may be other than those specified herein. Moreover, though devices have been shown and described in some detail herein, the scope and content hereof is not so limited, and instead may include alternative devices. Still furthermore, the connection mechanisms hereof are illustrative only as well and not limitative of the scope and content hereof. Other mechanisms may be used to the same or substantially the same effect, and thus be covered hereby.

It may also be that by adding or changing one or more of the sensors that this carbon monoxide detector could be adapted to detect carbon monoxide and other gases such as natural gas or LP (liquid propane) and other gases. It may readily be that a mechanical sensor may be substituted for either natural gas or LP, or it may be that a mechanical sensor could be substituted to detect more than just one gas; as for example, CO and LP and/or natural gas. Thus, one or more sensors may be added for one or more additional or alternative gases; or may be substituted for one or more of those described above.

Apparatuses hereof may be made by any of a variety of methods and/or of a variety of materials. Shapes and sizes of elements of the device are not limited to those shown and described here either, as sizes and shapes may be selected to adapt to any of many alternative structures. Although the present development has been described with reference to preferred implementations, workers skilled in the art will recognize that changes may be made in form and detail without departing from the spirit and scope of the development described herein.

What is claimed is:

1. A carbon monoxide detection apparatus comprising:
a carbon monoxide sensor; and
a humidity sensor,
wherein the humidity sensor provides a humidity determination used to assist the carbon monoxide sensor in the determination of a carbon monoxide quantity.

2. A carbon monoxide detection system, comprising:
a carbon monoxide detection device including:
control circuitry;
at least a first carbon monoxide sensor and a second carbon monoxide sensor each operatively connected to the control circuitry;
one or both of an audible alarm, and an appliance cutoff switch, operatively connected to the control circuitry, the appliance cutoff switch also operatively connected to an appliance;
wherein at least one of the first carbon monoxide sensor or second carbon monoxide sensor are adapted to detect a threshold level of carbon monoxide in response to which the carbon monoxide apparatus either one or both of: activates the appliance cutoff switch, and sounds an audible alarm.

3. The apparatus of claim 2, further comprising and a separate device connected to and controlled by the control circuitry; wherein when at least one of the first carbon monoxide sensor or second carbon monoxide sensor detect a threshold level of carbon monoxide, the carbon monoxide apparatus one or the other of activates or deactivates a separate device.

4. The apparatus of claim 2 further including a humidity sensor to assist in the determination of the carbon monoxide level.

5. The apparatus of claim 2, further comprising a visual alarm.

6. The apparatus of claim 5, wherein the visual alarm is one or more lights.

7. The apparatus of claim 2, further comprising at least one tube for sampling the level of carbon monoxide generated by the appliance.

8. The apparatus of claim 7, comprising a first tube and a second tube for sampling the level of carbon monoxide generated by the appliance.

9. The apparatus of claim 7, wherein one or both of:
the first tube is a 20 inch piece of 0.5 inch metal conduit or electrical metal tubing, with a 0.25 inch hole approximately every inch along the pipe; and,
the second tube is a 0.5 inch piece of metal conduit or electrical metal tubing approximately 2 inches long.

10. The apparatus of claim 7, wherein the first tube may have a plug at its end of the pipe or it may be crimped to seal its end so that it is drawing air through the 0.25 inch holes.

11. The apparatus of claim 7, wherein the second tube may be installed to create a draft through the first sampling tube.

12. The apparatus of claim 2, wherein the apparatus may be reset one of automatically after a predetermined period of time or manually.

13. The apparatus of claim 3, wherein the separate device is one or more of a garage door, a fan, a motor, a second hardwired alarm, a second wireless alarm, and a gas cutoff valve.

14. The apparatus of claim 2, wherein the level of carbon monoxide is about 10 to about 70 ppm.

15. The apparatus of claim 2, wherein the level of carbon monoxide is about 50 ppm or higher.

16. The apparatus of claim 7, wherein the first carbon monoxide sensor will detect the level of carbon monoxide in a first tube and sound the audible alarm in the presence of carbon monoxide in the range of 50 ppm or higher, and one or more of activate the appliance cutoff switch and activate or deactivate the separate device.

17. The apparatus of claim 7, wherein the second carbon monoxide sensor will detect the level of carbon monoxide in a second tube and sound the audible alarm in the presence of carbon monoxide in the range of 50 ppm or higher, and one or more of activate the appliance cutoff switch and activate or deactivate the separate device.

18. The apparatus of claim 2 further comprising a sensor for sensing one or more of natural gas or LP (liquid propane).

19. A system for detecting carbon monoxide and deactivating the source of the carbon monoxide, comprising:
a carbon monoxide detector having a control board, at least two carbon monoxide sensors, an audible alarm, and an appliance cutoff switch;
wherein at least one of the carbon monoxide sensors is adapted to detect a threshold level of carbon monoxide and either one or more of activate the appliance cutoff switch, sound an audible alarm, and activate or deactivate a separate device; and
an appliance that may be a source of carbon monoxide.

20. The system of claim 19, wherein the appliance is one or more of a furnace, a boiler, a water heater, a space heater, a range, an oven, a grill or other fuel burning appliance or any appliance that is capable of producing carbon monoxide.

21. The system of claim 19 further comprising a sensor for sensing one or more of natural gas or LP (liquid propane)

22. A method for detecting carbon monoxide including one or both of:
sensing carbon monoxide in a substantially continuous stream; and,
sensing carbon monoxide in a substantially continuous stream by a first sensor, and sensing a discrete carbon monoxide quantity in ambient air by a second sensor.

23. A method according to claim 22 wherein the substantially continuous stream of air is discrete from the ambient air.

24. A method of detecting carbon monoxide comprising:
detecting a threshold carbon monoxide quantity;
shutting off an appliance upon the detection of a threshold quantity.

25. A method of detecting carbon monoxide according to claim 24, further including:
sensing carbon monoxide levels in one or both of ambient air and in an air stream.

26. A method according to claim 24 further including sensing humidity to assist in the determination of the carbon monoxide level.

27. A method according to claim 24 further including sensing for one or more of natural gas or LP (liquid propane).

28. A method of detecting carbon monoxide and deactivating the source of the carbon monoxide according to claim 24, comprising:
mounting a carbon monoxide detecting device on a gas appliance;
placing sensors in a plenum or cold air return duct of the gas appliance;
using one or more carbon monoxide sensors within the carbon monoxide detecting device to detect a hazardous level of carbon monoxide emanating from an appliance and, if the level of carbon monoxide parts per million reaches a predetermined level; one or more of deactivating the gas appliance with an appliance cutoff switch, sounding an audible alarm, and activating or deactivating a separate device.

29. The method for detecting carbon monoxide and deactivating the source of the carbon monoxide of claim 28, wherein the appliance is one or more of a furnace, a boiler, a water heater, a space heater, a range, an oven, a grill or other fuel burning appliance or any appliance that is capable of producing carbon monoxide.

30. The method for detecting carbon monoxide and deactivating the source of the carbon monoxide of claim 28, wherein one or more sensors are changed so that the sensing is of carbon monoxide and one or more of natural gas or LP (liquid propane).
